(19) United States
(12) Patent Application Publication
(10) Pub. No.: US 2026/0261636 A1
(43) Pub. Date: Sep. 3, 2026

(54) ELECTRONIC APPARATUS AND CONTROL METHOD THEREOF

(71) Applicant: SAMSUNG ELECTRONICS CO., LTD., Suwon-si (KR)

(72) Inventor: Yunsung JUNG, Suwon-si (KR)

(73) Assignee: SAMSUNG ELECTRONICS CO., LTD., Suwon-si (KR)

(21) Appl. No.: 19/658,908

(22) Filed: Apr. 27, 2026

Related U.S. Application Data
(63) Continuation of application No. PCT/KR2024/019204, filed on Nov. 28, 2024.

(30) Foreign Application Priority Data
Dec. 18, 2023 (KR) 10-2023-0185035

(51) Int. Cl. H04N 9/31

(52) U.S. Cl. CPC H04N 9/3185; H04N 9/317

(57) ABSTRACT

An electronic device including a projection unit; a memory to store at least one piece of projection information; and at least one processor. The at least one processor is configured to: identify a projection position and a projection angle corresponding to a projection surface position on which an image is to be output based on a user command; acquire correction information included in projection information corresponding to the projection surface position among the at least one piece of stored projection information; and move the projection position onto a region corresponding to the projection surface position that is corrected based on the correction information and control the projection unit to output the image which is acquired using keystone correction based on the region corresponding to the projection surface position corrected through the correction information.

### CROSS-REFERENCE TO RELATED APPLICATIONS

This application is a continuation application, under 35 U.S.C. § 111(a), of international application No. PCT/KR2024/019204, filed Nov. 28, 2024, which claims priority under 35 U.S.C. § 119 to Korean Patent Application No. 10-2023-0185035, filed Dec. 18, 2023, the disclosures of which are incorporated herein by reference in their entireties.

### TECHNICAL FIELD

The present disclosure relates to an electronic apparatus and a control method thereof, and more particularly, to an electronic apparatus for outputting a projection image onto a projection surface in consideration of a correction history, and a control method thereof.

### BACKGROUND ART

An image distortion (or error) may occur in an electronic apparatus that outputs a projection image based on a projection surface position, a projection position, the projection angle, and the like.

When a position of the electronic apparatus is fixed, the projection surface position may also be fixed. However, when a size of the projection surface is changed, a user may experience inconvenience in that a new setting needs to be performed.

When a position of the electronic apparatus is not fixed, the projection surface position, a projection position, the projection angle, and the like may be changed each time a projection function is performed, and accordingly, a user may experience inconvenience in that a new setting needs to be performed each time.

Even when a setting is automatically performed, an error may occur depending on the hardware performance or environment of an electronic apparatus. When an error occurs, distortion occurring in a projection image may become severe or focus may not be achieved.

### DISCLOSURE OF INVENTION

### Solution to Problem

The present disclosure provides an electronic apparatus for outputting a projection image by correcting a setting for a current projection surface in consideration of stored correction history related to the output of the projection image and a control method thereof.

According to an embodiment of the present disclosure, provided is an electronic apparatus including: a projection unit; a memory to store at least one projection information; and at least one processor, wherein the at least one processor is configured to: identify a projection position and a projection angle corresponding to a projection surface position on which an image is to be output based on a user command; acquire correction information included in projection information corresponding to the projection surface position among the at least one projection information stored in the memory; and move the projection position onto a region corresponding to the projection surface position that is corrected based on the correction information and control the projection unit to output the image which is acquired using keystone correction based on the region corresponding to the projection surface position corrected (or changed) based on the correction information.

The memory may store first projection information including at least one of a first projection surface position or first correction information, the first correction information may include information for correcting the first projection surface position to a third projection surface position, and the at least one processor may be configured to: identify whether a second projection surface position identified based on the user command corresponds to the first projection surface position.

The at least one processor may be configured to: when the second projection surface position corresponds to the first projection surface position, correct the second projection surface position to the third projection surface position based on the first correction information included in the first projection information; and move to output the image onto the third projection surface position.

The at least one processor may be configured to: acquire a first projection direction corresponding to the first projection surface position when the second projection surface position corresponds to the first projection surface position; acquire a second projection direction corresponding to the second projection surface position; and change the second projection surface position to the third projection surface position based on the first correction information when the second projection direction corresponds to the first projection direction.

The at least one processor may be configured to: acquire the first projection direction based on a first projection position included in the first projection information and the first projection surface position; acquire the second projection direction based on a second projection position corresponding to the second projection surface position and the second projection surface position; and identify whether the second projection direction corresponds to the first projection direction based on a difference value between the first projection direction and the second projection direction.

The at least one processor may be configured to: change the second projection surface position to the third projection surface position based on the first correction information when the difference value between the first projection direction and the second projection direction is less than a threshold value.

The at least one processor may be configured to: when the difference value between the first projection direction and the second projection direction is not less than a threshold value, change the first correction information to second correction information based on the difference value, and change the second projection surface position to a fourth projection surface position based on the second correction information.

The at least one processor may be configured to: change at least one of the projection position or the projection angle based on the corrected projection surface position; and control the projection unit to output the image acquired using the keystone correction based on at least one of the corrected projection surface position, the projection position that is changed, or the projection angle that is changed.

The at least one processor may be configured to: verify at least one of the corrected projection surface position, the projection position, or the projection angle after the movement to the projection position; and control the projection unit to output the image acquired using the keystone correction based on a verification result.

The at least one processor may be configured to: control the projection unit to output the image during the movement to the projection position.

According to an embodiment of the present disclosure, provided is a control method of an electronic apparatus storing at least one projection information, the method including: identifying a projection position and a projection angle corresponding to a projection surface position on which an image is to be output based on a user command; acquiring correction information included in projection information corresponding to the projection surface position among the at least one projection information that is stored; and moving the projection position onto a region corresponding to the projection surface position that is corrected based on the correction information and outputting the image which is acquired using keystone correction based on the region corresponding to the projection surface position corrected based on the correction information.

The electronic apparatus may store first projection information including at least one of a first projection surface position or first correction information, the first correction information may include information for correcting the first projection surface position to a third projection surface position, and the method may include: identifying whether a second projection surface position identified based on the user command corresponds to the first projection surface position.

The method may include: when the second projection surface position corresponds to the first projection surface position, correcting the second projection surface position to the third projection surface position based on the first correction information included in the first projection information, and the method may include: performing movement to output the image onto the third projection surface position.

The method may include: acquiring a first projection direction corresponding to the first projection surface position when the second projection surface position corresponds to the first projection surface position; acquiring a second projection direction corresponding to the second projection surface position; and changing the second projection surface position to the third projection surface position based on the first correction information when the second projection direction corresponds to the first projection direction.

The method may include: acquiring the first projection direction based on a first projection position included in the first projection information and the first projection surface position; acquiring the second projection direction based on a second projection position corresponding to the second projection surface position and the second projection surface position; and identifying whether the second projection direction corresponds to the first projection direction based on a difference value between the first projection direction and the second projection direction.

The method may include: changing the second projection surface position to the third projection surface position based on the first correction information when the difference value between the first projection direction and the second projection direction is less than a threshold value.

The method may include: when the difference value between the first projection direction and the second projection direction is not less than a threshold value, changing the first correction information to second correction information based on the difference value, and changing the second projection surface position to a fourth projection surface position based on the second correction information.

The generating of the image may include: changing at least one of the projection position or the projection angle based on the corrected projection surface position; and outputting the image acquired using the keystone correction based on at least one of the corrected projection surface position, the projection position that is changed, or the projection angle that is changed.

The generating of the image may include: verifying at least one of the corrected projection surface position, the projection position, or the projection angle after the movement to the projection position; and outputting the image acquired using the keystone correction based on a verification result.

The method may include outputting the image during the movement to the projection position.

### BRIEF DESCRIPTION OF DRAWINGS

FIG. 1 is a block diagram illustrating an electronic apparatus according to an embodiment.

FIG. 2 is a block diagram illustrating a specific configuration of the electronic apparatus illustrated in FIG. 1 according to an embodiment.

FIG. 3 is a block diagram illustrating at least one module included in the electronic apparatus according to an embodiment.

FIG. 4 is a diagram illustrating an operation of outputting a projection image by performing keystone correction according to an embodiment.

FIG. 5 is a diagram illustrating an operation of storing projection information according to an embodiment.

FIG. 6 is a diagram illustrating an operation of identifying projection information corresponding to a projection surface according to an embodiment.

FIG. 7 is a diagram illustrating a detailed operation of identifying projection information corresponding to a projection surface according to an embodiment.

FIG. 8 is a diagram illustrating an operation of comparing projection directions according to an embodiment.

FIG. 9 is a diagram illustrating a detailed operation of comparing projection directions according to an embodiment.

FIG. 10 is a diagram illustrating a horizontal tilt according to an embodiment.

FIG. 11 is a diagram illustrating a vertical tilt according to an embodiment.

FIG. 12 is a diagram illustrating horizontal misalignment according to an embodiment.

FIG. 13 is a diagram illustrating rotation information of the electronic apparatus according to an embodiment.

FIG. 14 is a diagram illustrating rotation information of a projection surface according to an embodiment.

FIG. 15 is a diagram illustrating z-axis rotation information of the projection surface according to an embodiment.

FIG. 16 is a diagram illustrating y-axis rotation information of the projection surface according to an embodiment.

FIG. 17 is a diagram illustrating an operation of performing a keystone function in consideration of a vertical tilt according to an embodiment.

FIG. 18 is a diagram illustrating an operation of performing the keystone function in consideration of a horizontal tilt according to an embodiment.

FIG. 19 is a diagram illustrating an operation of storing projection information according to an embodiment.

FIG. 20 is a diagram illustrating an operation of performing correction based on projection information according to an embodiment.

FIG. 21 is a diagram illustrating an operation of performing correction based on projection information according to an embodiment.

FIG. 22 is a diagram illustrating an operation of performing correction based on projection information according to an embodiment.

FIG. 23 is a diagram illustrating an operation of performing verification after movement to a projection position according to an embodiment.

FIG. 24 is a diagram illustrating an operation of performing verification after movement to a projection position according to an embodiment.

FIG. 25 is a diagram illustrating an operation of determining a projection reference point in consideration of a user position according to an embodiment.

FIG. 26 is a diagram illustrating an operation of performing keystone correction in consideration of a projection reference point according to an embodiment.

FIG. 27 is a diagram illustrating an operation of outputting a projection image during movement of the electronic apparatus according to an embodiment.

FIG. 28 is a diagram illustrating a control operation of an electronic apparatus according to an embodiment.

### MODE FOR INVENTION

Hereinafter, the present disclosure will be described in detail with reference to the accompanying drawings.

General terms currently widely used are selected as terms used in the embodiments of the present disclosure in consideration of their functions in the present disclosure and may be changed based on the intentions of those skilled in the art or a judicial precedent, the emergence of a new technique, or the like. In addition, in a specific case, terms arbitrarily selected by an applicant may be present. Here, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the specification, the expression such as “have,” “may have,” “include,” or “may include,” indicates the presence of a corresponding feature (for example, a numerical value, a function, an operation, or a component such as a part), and does not exclude the presence of an additional feature.

An expression such as “at least one of A or/and B” may indicate either “A or B,” or “both of A and B.”

Expressions such as “first” and “second,” used in the present disclosure may indicate various components regardless of the sequence or importance of the components. The expression is used only to distinguish one component from another component and does not limit the corresponding component.

When any component (e.g., a first component) is mentioned to be “(operatively or communicatively) coupled with/to” or “connected to” another component (e.g., a second component), it should be understood that the component is directly coupled to another component or may be coupled to another component through yet another component (e.g., a third component).

A term of a singular number may include its plural number unless explicitly indicated otherwise in the context. It should be understood that in this application, terms such as “include” or “have” indicate that the presence of the features, numbers, steps, operations, components, parts, or combinations thereof, which are described in the specification, and do not preclude the presence or addition of one or more other features, numbers, steps, operations, components, parts, or combinations thereof.

In the present disclosure, a “module” or a “part” may perform at least one function or operation and be implemented by hardware or software or be implemented by a combination of hardware and software. In addition, a plurality of “modules” or a plurality of “parts” may be integrated into at least one module and be implemented by at least one processor (not shown) except for a “module” or a “part” that needs to be implemented by specific hardware.

In the specification, a term such as a “user” may refer to a person who uses an electronic apparatus or an apparatus (e.g., an artificial intelligence electronic apparatus) which uses an electronic apparatus.

Hereinafter, embodiments of the present disclosure are described in more detail with reference to the accompanying drawings.

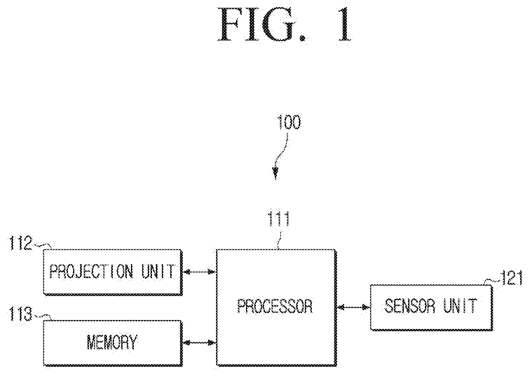

FIG. 1 is a block diagram illustrating an electronic apparatus 100 according to an embodiment.

Referring to FIG. 1, the electronic apparatus 100 may include at least one of at least one processor 111, a projection unit 112, or a memory 113.

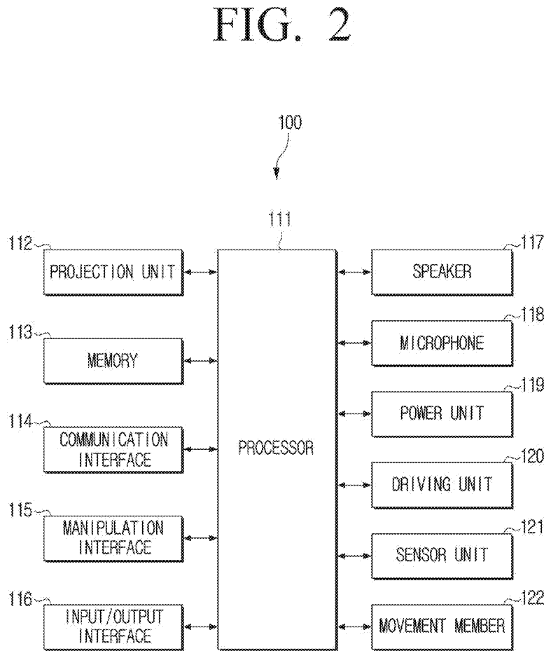

At least one processor 111 may control overall operations of the electronic apparatus 100. Specifically, at least one processor 111 may perform a function of controlling overall operations of the electronic apparatus 100. A detailed description related to at least one processor 111 is described with reference to FIG. 2.

The projection unit 112 is a component for projecting an image (e.g., a projection image, or content) to the outside. A detailed description related to the projection unit 112 is described with reference to FIG. 2.

The memory 113 may store a projection image projected by the projection unit 112. The projection image may indicate not only a still image but also a continuous image (or a moving image). The projection image may indicate an image included in content. The memory 113 may store a driving operating system (OS).

At least one processor 111 may control operations performed by the electronic apparatus 100.

The memory 113 may store at least one projection information. The projection information may include various information used in performing a projection operation. The projection information may include at least one of information related to a projection surface or information required to perform a projection function.

For example, at least one processor 111 may store one projection information.

For example, at least one processor 111 may store two or more projection information. At least one processor 111 may store a plurality of projection information. Each of the plurality of projection information may be distinguished based on a projection surface. When different projection surfaces are provided, at least one processor 111 may store separate projection information in the memory 113. For example, the plurality of projection information stored in the memory 113 may include first projection information for a first projection surface and second projection information for a second projection surface.

The projection information stored in the memory 113 may be described as the first projection information, and the first projection information may include at least one of a first projection surface position, a first projection position, a first projection angle, or first correction information. The first projection surface position, the first projection position, the first projection angle, and the first correction information may be information used (or recorded) at a past time point.

At least one projection information may be included in history information. The history information may be stored in the memory 113. The history information may include information indicating a projection history. The projection information may include data at a past time point related to a projection operation recorded by the electronic apparatus 100. The projection information may include various information related to projection.

The projection information may include at least one of the projection surface position, a projection position, a projection angle, or correction information used when the electronic apparatus 100 performed a projection function. The projection information may include various information related to a projection function acquired at a past time point.

The projection surface position included in the projection information may include coordinates indicating the projection surface position onto which a projection image is output. The projection surface position may be described as the projection surface position information, projection surface coordinates, projection surface coordinate information, or the like.

For example, the projection surface position may be determined based on a user selection.

For example, the projection surface position may be a predetermined region.

For example, the projection surface position may be a region identified by the electronic apparatus 100. At least one processor 111 may identify a projection surface appropriate for outputting a projection image.

The projection position included in the projection information may indicate a position at which a projection image is output. The projection position may be described as projection position information, projection coordinates, projection coordinate information, or the like.

The projection surface position and the projection position may each be defined based on predetermined coordinate axes.

For example, the projection surface position and the projection position may each include two-dimensional coordinates. The two-dimensional coordinates may include an x coordinate and a y coordinate.

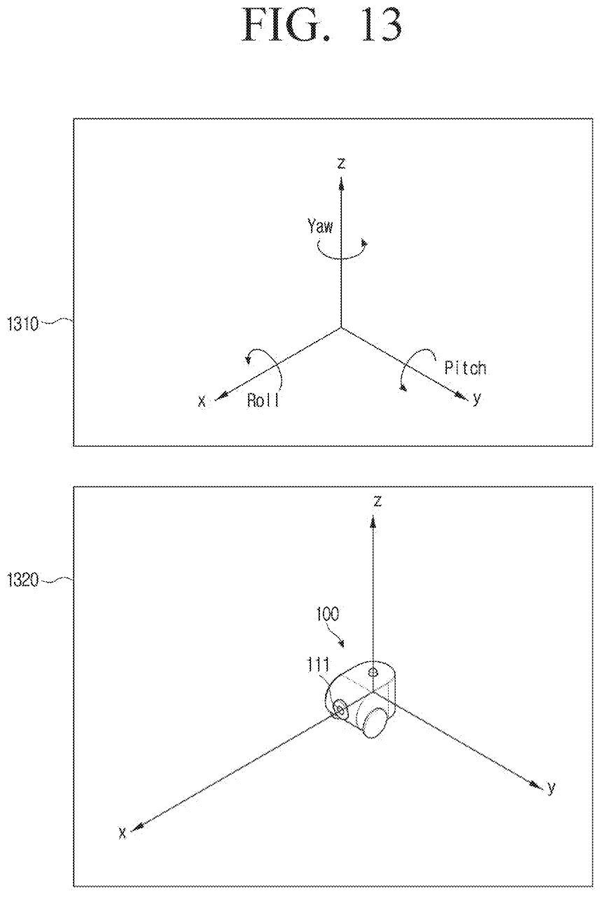

For example, the projection surface position and the projection position may each include three-dimensional coordinates. The three-dimensional coordinates may include an x coordinate, a y coordinate, and a z coordinate. A description thereof is provided with reference to FIG. 13.

The x coordinate may be described as a first axis coordinate. The y coordinate may be described as a second axis coordinate. The z coordinate may be described as a third axis coordinate.

The projection angle included in the projection information may indicate an output direction of a projection image at a time point at which the projection image is output. The projection angle may include a projection rotation direction used in outputting the projection image.

The projection angle may be defined based on predetermined coordinate axes.

For example, the projection angle may define a roll angle, a pitch angle, and a yaw angle. A description thereof is provided with reference to FIG. 13.

The roll angle may be described as a first axis rotation angle. The pitch angle may be described as a second axis rotation angle. The yaw angle may be described as a third axis rotation angle.

The correction information included in the projection information may include information indicating a history of changing at least one of an initially determined the projection surface position, projection position, or projection angle. The correction information may include correction setting values input by a user (or automatically applied) at a past time point.

For example, when the projection surface position is changed from an initially set value, the correction information may include a changed value. The correction information may include various information related to user correction related to a projection function. The correction information may include projection setting information, projection setting value change information, projection function change information, the projection surface position movement information, or projection angle change information.

The correction information may be described as a correction history. The correction information may include at least one of a correction position(a position to be corrected or a corrected position) or a correction angle(an angle to be corrected or a corrected angle). The correction position may include at least one of a position correction value or an angle correction value. The position correction value may include at least one of a position correction value corresponding to a projection surface or a position correction value corresponding to a projection position.

For example, the correction position may include the correction position corresponding to a projection surface.

For example, the correction position may include the correction position corresponding to a projection position.

The correction angle may indicate correction for a projection direction.

When a correction function (or a correction operation) is performed in outputting a projection image on a projection surface corresponding to projection information, correction information may be included in the projection information.

According to an embodiment, when the projection surface position is corrected, a projection position and the projection angle may be changed to correspond to the corrected (or changed) projection surface position.

According to an embodiment, each of the projection surface position, a projection position, and the projection angle may be corrected (or changed).

At least one processor 111 may determine the projection surface position based on a user command, determine a projection position and the projection angle corresponding to the projection surface position, identify projection information corresponding to the projection surface position among at least one stored projection information, acquire correction information included in the identified projection information, change the projection surface position based on the correction information, generate a projection image by performing keystone correction based on the corrected (or changed) projection surface position, and control the projection unit 112 to output the generated projection image onto a region corresponding to the corrected projection surface position after movement to the projection position.

At least one processor 111 may acquire a user command. At least one processor 111 may acquire the user command including a command for outputting a projection image. The user command may be described as a user input.

For example, at least one processor 111 may acquire the user command through a manipulation interface 115 included in the electronic apparatus 100.

For example, at least one processor 111 may acquire the user command through a microphone 118 included in the electronic apparatus 100.

For example, at least one processor 111 may acquire the user command from an external device (e.g., a remote controller) connected to the electronic apparatus 100.

At least one processor 111 may determine the projection surface position based on a user command. At least one processor 111 may identify the determined the projection surface position. The position of the projection surface may be described as the projection surface position.

When the projection surface position is determined, at least one processor 111 may determine a projection position and the projection angle corresponding to the projection surface position. At least one processor 111 may output a projection image from the projection position onto the projection surface position. At least one processor 111 may identify (or acquire) the projection angle to determine at which angle a projection image is output from the projection position.

At least one processor 111 may identify projection information corresponding to the projection surface position among at least one projection information stored in the memory 113.

For convenience of distinguishing, information included in the projection information is described as including a first projection surface position, a first projection position, a first projection angle, or first correction information.

The projection surface position, a projection position, and the projection angle determined after a user command is received may be described as a second projection surface position, a second projection position, and a second projection angle.

At least one processor 111 may acquire the first projection surface position based on the first projection information stored in the memory 113. At least one processor 111 may identify whether the second projection surface position corresponds to the first projection surface position.

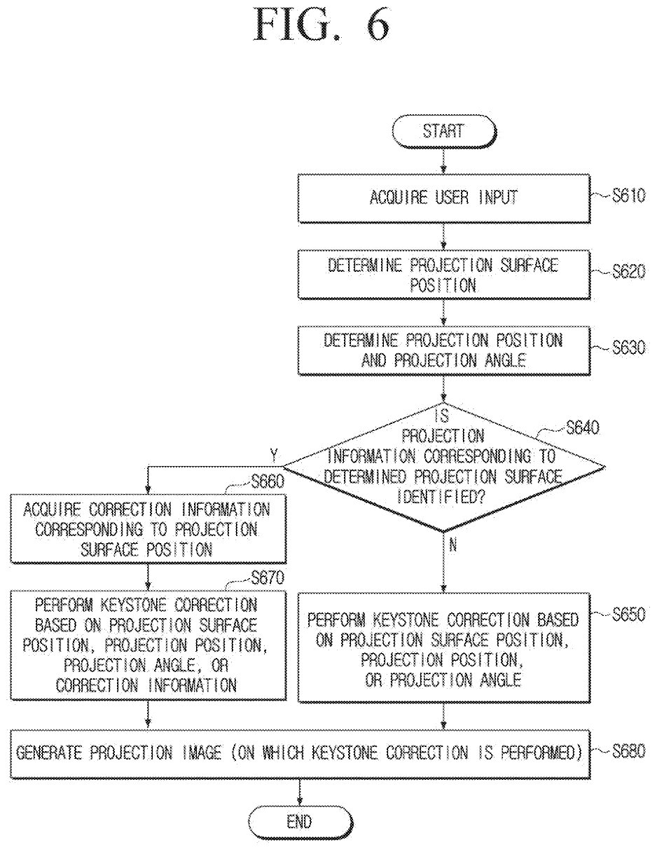

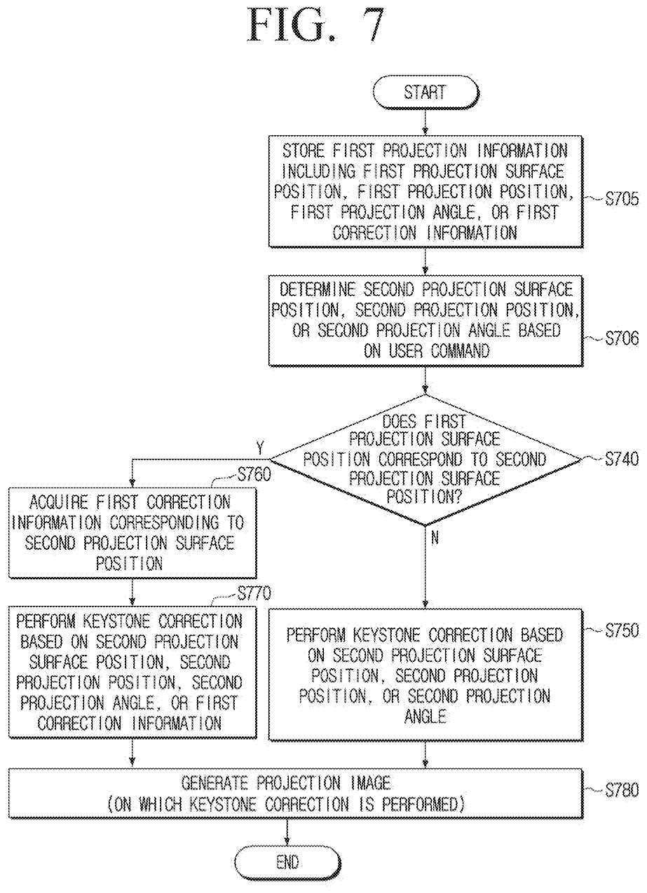

An operation corresponding to the projection surface position is described with reference to FIGS. 6 and 7.

The memory 113 may store the first projection information including at least one of the first projection surface position or the first correction information. The first correction information may be information used to change the first projection surface position. At least one processor 111 may determine the second projection surface position based on a user command and may identify whether the second projection surface position corresponds to the first projection surface position.

At least one processor 111 may acquire a distance (or a difference value) between the first projection surface position and the second projection surface position. When the distance is less than a threshold value, at least one processor 111 may identify that the first projection surface position and the second projection surface position correspond to each other.

When the second projection surface position corresponds to the first projection surface position, at least one processor 111 may acquire the first correction information included in the first projection information, change the second projection surface position to a third projection surface position based on the first correction information, and move the electronic apparatus 100 to the third projection surface position.

At least one processor 111 may identify projection information including the projection surface position corresponding to the second projection surface position among at least one projection information stored in the memory 113. When the second projection surface position corresponds to the first projection surface position among at least one projection surface position stored in the memory 113, at least one processor 111 may identify the first projection information corresponding to the first projection surface position.

At least one processor 111 may identify whether the first projection information includes correction information. At least one processor 111 may identify the first correction information included in the first projection information.

At least one processor 111 may change (or correct) the second projection surface position to the third projection surface position based on the first correction information. When the first projection information includes the first correction information, at least one processor 111 may determine that correction is performed for the first projection surface indicating the first projection surface position. At least one processor 111 may perform a correction operation in the same manner for the second projection surface position based on the first correction information.

At least one processor 111 may move the electronic apparatus 100 to output a projection image to the changed third projection surface position. At least one processor 111 may acquire the new projection surface position based on the third projection surface position. At least one processor 111 may change the second projection position to a third projection position to output a projection image at the third projection surface position. At least one processor 111 may move the electronic apparatus 100 to the third projection position.

At least one processor 111 may acquire a new projection angle based on the third projection surface position and the third projection position. At least one processor 111 may acquire a third projection angle based on the third projection surface position and the third projection position.

At least one processor 111 may control the projection unit 112 to output a projection image to the third projection surface position at the third projection position based on the third projection angle.

When it is identified that the second projection surface position determined (or acquired) based on the user command is identical to (or corresponds to) the first projection surface position stored in the memory 113, at least one processor 111 may change the second projection surface position to the third projection surface position based on the first correction information corresponding to the first projection surface position.

According to an embodiment, at least one processor 111 may determine whether to change the first correction information in consideration of a projection direction.

When it is identified that the second projection surface position is identical to the first projection surface position stored in the memory 113, at least one processor 111 may compare a first projection direction for outputting a projection image at the first projection surface position (or the first projection surface) with a second projection direction for outputting a projection image at the second projection surface position (or the second projection surface). At least one processor 111 may determine whether to change the first correction information based on a comparison result of the first projection direction and the second projection direction.

At least one processor 111 may acquire the first projection direction based on the first projection position and the first projection surface position included in the first projection information, acquire the second projection direction based on the second projection position corresponding to the second projection surface position and the second projection surface position, and identify whether the second projection direction corresponds to the first projection direction based on a difference value between the first projection direction and the second projection direction.

When the difference value between the first projection direction and the second projection direction is less than a threshold value, at least one processor 111 may change the second projection surface position to the third projection surface position based on the first correction information.

When the difference value between the first projection direction and the second projection direction is not less than the threshold value, at least one processor 111 may change the first correction information to second correction information based on the difference value, and may change the second projection surface position to a fourth projection surface position based on the second correction information.

At least one processor 111 may acquire the first projection direction corresponding to the first projection surface position when the second projection surface position corresponds to the first projection surface position, acquire the second projection direction corresponding to the second projection surface position, and change the second projection surface position to the third projection surface position based on the first correction information when the second projection direction corresponds to the first projection direction.

At least one processor 111 may acquire the first projection direction including a direction vector from the first projection position to the first projection surface position. At least one processor 111 may acquire the second projection direction including a direction vector from the second projection position to the second projection surface position.

At least one processor 111 may identify whether the second projection direction corresponds to the first projection direction. At least one processor 111 may acquire a difference value between the second projection direction and the first projection direction. When the difference value is less than a threshold value, at least one processor 111 may identify that the second projection direction corresponds to the first projection direction.

When the difference value is less than the threshold value, at least one processor 111 may not change the first correction information. At least one processor 111 may change the second projection surface position to the third projection surface position based on the first correction information.

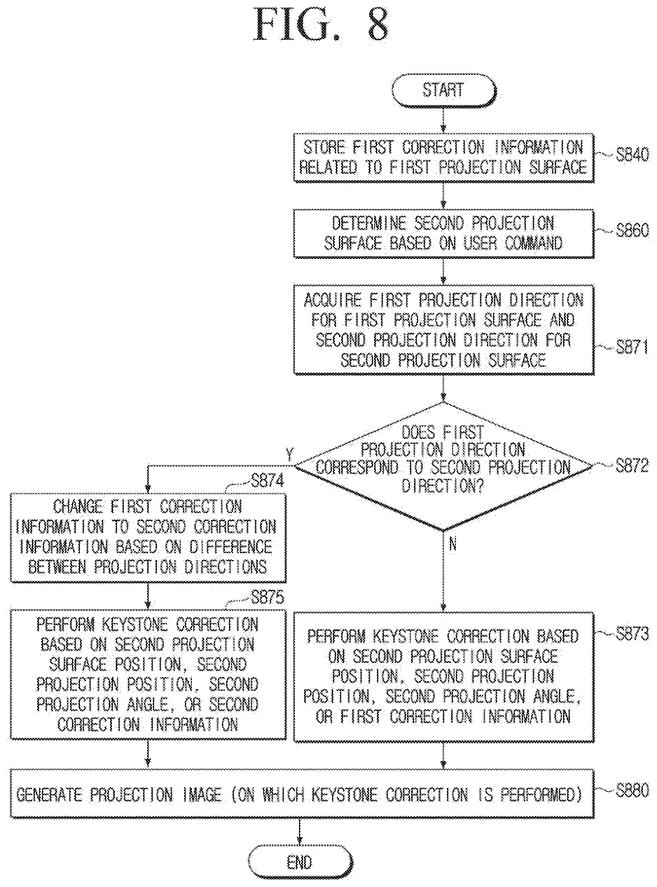

When the difference value is equal to or greater than the threshold value, at least one processor 111 may change the first correction information to the second correction information based on the difference value. At least one processor 111 may change the second projection surface position to the fourth projection surface position based on the second correction information. For example, when projection directions differ by 180 degrees, at least one processor 111 may multiply a negative value to some coordinate values of the direction. A detailed description thereof is provided with reference to FIGS. 8, 9, 20, 21, and 22.

The first projection direction and the second projection direction may be described as first projection direction information and second projection direction information.

The first projection direction and the second projection direction may be described as a first projection vector and a second projection vector.

At least one processor 111 may change at least one of a projection position or the projection angle based on a corrected projection surface position and may generate a projection image by performing the keystone correction based on at least one of the corrected projection surface position, the changed projection position, or the changed projection angle.

For example, at least one processor 111 may change the second projection position to the third projection position based on the changed projection surface position (the third projection surface position or the fourth projection surface position).

For example, at least one processor 111 may change the second projection angle to the third projection angle based on the changed projection surface position (the third projection surface position or the fourth projection surface position).

For example, at least one processor 111 may change the second projection angle to the third projection angle based on the changed projection surface position (the third projection surface position or the fourth projection surface position) and the changed projection position (the third projection position).

At least one processor 111 may perform the keystone correction based on at least one of the changed projection surface position (the third projection surface position or the fourth projection surface position), the changed projection position (the third projection position), or the changed projection angle (the third projection angle).

At least one processor 111 may verify at least one of the changed projection surface position, the projection position, or the projection angle after movement of the electronic apparatus 100 to the projection position, and may generate a projection image by performing the keystone correction based on a verification result.

At least one processor 111 may verify at least one of the projection surface position, the projection position, or the projection angle. A verification operation may include an operation of determining whether a calculation result is appropriate after actual movement of the electronic apparatus 100 to a region within a threshold distance from the projection surface position.

For example, at least one processor 111 may verify the changed third projection surface position (or the fourth projection surface position). At least one processor 111 may verify whether the changed projection surface position is substantially appropriate for a user. When an obstacle is present at the changed projection surface position or it is identified that a projection image is incapable of being output/the output of a projection image is not available, at least one processor 111 may identify a new projection surface position (a fifth projection surface position).

For example, at least one processor 111 may verify the changed third projection position. At least one processor 111 may identify whether a projection image is output from the third projection position to the changed projection surface position. When an obstacle object is present, a projection image may not be normally output from the third projection position. For example, when an obstacle object is identified at the third projection position, at least one processor 111 may change the third projection position to a fourth projection position.

For example, at least one processor 111 may verify the changed third projection angle. At least one processor 111 may determine whether a projection image is output to the third projection surface position at the third projection position and at the third projection angle. When it is determined that the projection image is not normally output, at least one processor 111 may change the third projection angle to a fourth projection angle.

At least one processor 111 may control the projection unit 112 to output a projection image during the movement of the electronic apparatus 100 to the projection position.

To provide a projection image to a user as fast as possible, at least one processor 111 may output the projection image during a movement process. At least one processor 111 may generate a control command for movement from a current position to the projection position. At least one processor 111 may identify a movement path from the current position to the projection position.

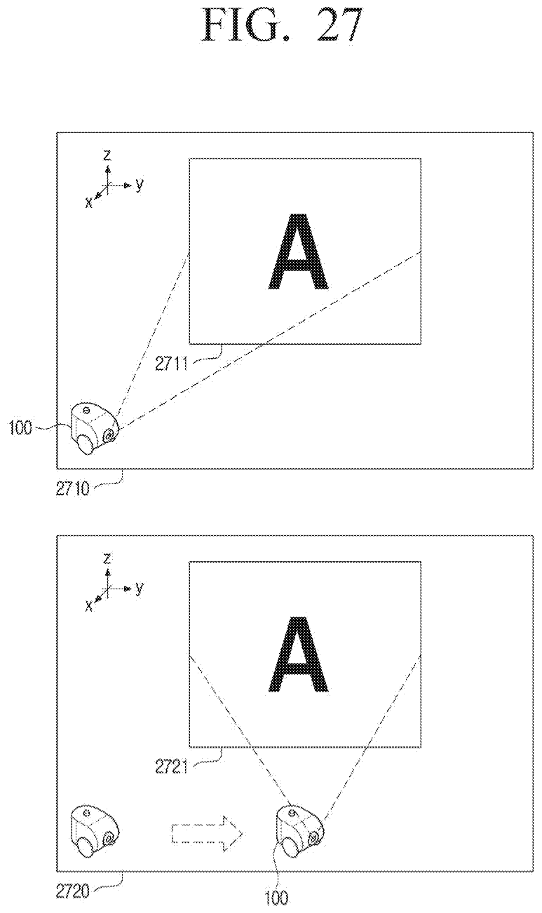

At least one processor 111 may perform the keystone correction based on each position included in the movement path. At least one processor 111 may continuously output a projection image onto the projection surface position by performing the keystone correction appropriate for each position. A description thereof is provided with reference to FIG. 27.

According to an embodiment, a process of calculating a projection position and the projection angle determined based on a user command may be performed after the projection surface position is changed.

According to an embodiment, a process of calculating a projection position and the projection angle based on a user command may be performed based on map data. The map data may indicate a map related to a space in which the electronic apparatus 100 is disposed. At least one processor 111 may identify at least one of the projection surface position, a projection position, or the projection angle based on the map data. The map data may be defined as two-dimensional coordinates or three-dimensional coordinates.

When outputting a projection image onto a projection surface, the electronic apparatus 100 may use previous history information. At least one processor 111 may identify a correction history included in the history information. When the same correction history is applied as it is to the same projection surface, unnecessary user manipulation may be reduced.

The electronic apparatus 100 is described as a mobile device. According to various embodiments, the electronic apparatus 100 may be a fixed device.

FIG. 2 is a block diagram illustrating a specific configuration of the electronic apparatus 100 illustrated in FIG. 1 according to an embodiment.

Referring to FIG. 2, the electronic apparatus 100 may include at least one of at least one processor 111, the projection unit 112, the memory 113, a communication interface 114, the manipulation interface 115, an input/output interface 116, a speaker 117, the microphone 118, a power unit 119, a driving unit 120, the sensor unit 121, or a movement member 122.

The configuration illustrated in FIG. 2 is merely various embodiments, and some components may be omitted or new components may be added.

A description already provided with reference to FIG. 1 is omitted.

At least one processor 111 may be implemented as a digital signal processor (DSP), a microprocessor, or a time controller (TCON) for processing a digital signal. However, the present disclosure is not limited thereto, and at least one processor 111 may include or be defined as at least one of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machines (ARM) processor. At least one processor 111 may be implemented as a system-on-chip (SoC) or a large scale integration (LSI) in which a processing algorithm is embedded, or may be implemented in a form of a field programmable gate array (FPGA). At least one processor 111 may perform various functions by executing computer executable instructions stored in the memory 113.

The projection unit 112 is a component for projecting an image to the outside. According to various embodiments of the present disclosure, the projection unit 112 may be implemented in various projection schemes (e.g., a cathode-ray tube (CRT) scheme, a liquid crystal display (LCD) scheme, a digital light processing (DLP) scheme, or a laser scheme). For example, the CRT scheme may basically use the same principle as a CRT monitor. In the CRT scheme, an image may be displayed on a screen by enlarging an image through a lens in front of a CRT. The CRT scheme may be classified into a single-tube type and a three-tube type based on the number of CRTs, and in the three-tube type, red, green, and blue CRTs may be separately implemented.

In another example, the LCD scheme refers to a scheme of displaying an image by transmitting light emitted from a light source through liquid crystals. The LCD scheme may be classified into a single-panel type and a three-panel type. In the three-panel type, light emitted from the light source may be separated into red, green, and blue by a dichroic mirror (a mirror that reflects only light of a specific color and transmits the rest), transmitted through liquid crystals, and then collected again into one point.

In another example, the digital light processing (DLP) scheme refers to a scheme of displaying an image by using a digital micromirror device (DMD) chip. A projection unit using the DLP scheme may include a light source, a color wheel, a DMD chip, a projection lens, or the like. Light output from the light source may be colored while passing through a rotating color wheel. Light passing through the color wheel may be input to the DMD chi. The DMD chip may include a large number of micromirrors and reflect light input to the DMD chip. The projection lens may perform a function of enlarging light reflected from the DMD chip to an image size.

In another example, the laser method may include a diode pumped solid state (DPSS) laser and a galvanometer. A laser that outputs various colors may use a laser in which three DPSS lasers are installed for each of red, green, and blue (RGB) colors and then optical axes are overlapped by using a special mirror. The galvanometer may include a mirror and a high-output motor and move the mirror at a high speed. For example, the galvanometer may rotate the mirror at up to 40 KHz/sec. The galvanometer may be mounted on a projector based on a scanning direction, and in general, a projector may perform planar scanning, and galvanometers may thus also be disposed to correspond to an x-axis and a y-axis.

The projection unit 112 may include various types of light sources. For example, the projection unit 112 may include at least one light source among a lamp, a light-emitting diode (LED), or a laser.

The projection unit 112 may output an image at a 4:3 aspect ratio, a 5:4 aspect ratio, or a 16:9 wide aspect ratio based on a use of the electronic apparatus 100, a user setting, or the like, and may output an image at various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels or 1280×800 pixels), super extended graphics array (SXGA, 1280×1024 pixels), ultra extended graphics array (UXGA, 1600×1200 pixels), full high-definition (full HD, 1920×1080 pixels) based on the aspect ratio.

The projection unit 112 may perform various functions for adjusting an output image under control of at least one processor 111. For example, the projection unit 112 may perform functions such as zoom, keystone, quick corner (four-corner) keystone, and lens shift.

Specifically, the projection unit 112 may enlarge or reduce an image based on a distance (a projection distance) to a screen. That is, a zoom function may be performed based on the distance to the screen. In this case, the zoom function may include a hardware method of adjusting a screen size by moving a lens and a software method of adjusting a screen size by cropping an image. When the zoom function is performed, focus adjustment of an image is required. For example, a focus adjustment method may include a manual focus method and a motor-driven method. The manual focus method indicates a method of manually adjusting focus, and the motor-driven method indicates a method of automatically adjusting focus by using a motor embedded in a projector when the zoom function is performed. When performing the zoom function, the projection unit 112 may provide a digital zoom function by using software and may provide an optical zoom function of performing a zoom function by moving a lens by using the driving unit 120.

The projection unit 112 may perform the keystone correction function. When a projection height does not match during front projection, a screen may be distorted upward or downward. The keystone correction function indicates a function of correcting a distorted screen. For example, when distortion occurs in a left-right direction of a screen, the distortion may be corrected by using a horizontal keystone, and when distortion occurs in an up-down direction, the distortion may be corrected by using a vertical keystone. A quick corner (four-corner) keystone correction function indicates a function of correcting a screen when a central region of the screen is normal and a corner region thereof is not balanced. A lens shift function indicates a function of moving a screen as it is when the screen is out of a projection range.

The projection unit 112 may automatically provide zoom/keystone/focus functions by analyzing a surrounding environment and a projection environment without a user input. Specifically, the projection unit 112 may automatically provide zoom/keystone/focus functions based on a distance between the electronic apparatus 100 and a screen sensed by a sensor (e.g., a depth camera, a distance sensor, an infrared sensor, or an illuminance sensor), information regarding a space in which the electronic apparatus 100 is currently positioned, information regarding surrounding light amounts, or the like.

The projection unit 112 may provide an illumination function by using a light source. In particular, the projection unit 112 may provide an illumination function by outputting a light source by using a light-emitting diode (LED). According to various embodiments, the projection unit 112 may include a single LED, and according to another embodiment, the electronic apparatus 100 may include a plurality of LEDs. The projection unit 112 may output a light source by using a surface-emitting LED in an implementation example. The surface-emitting LED may indicate an LED having an optical sheet disposed above the LED to uniformly distribute and output a light (light source). Specifically, when a light source is output through the LED, the light source may be evenly distributed through the optical sheet, and the light source distributed through the optical sheet may be incident to a display panel.

The projection unit 112 may provide a user with a dimming function for adjusting the intensity of a light source. Specifically, when a user input for adjusting an intensity of a light source is received from a user through the manipulation interface 115 (e.g., a touch display button or a dial), the projection unit 112 may control the LED to output an intensity of a light source corresponding to the received user input.

The projection unit 112 may provide the dimming function based on content analyzed by at least one processor 111 without a user input. Specifically, the projection unit 112 may control the LED to output an intensity of a light source based on information regarding content currently provided (e.g., a content type or content brightness).

The projection unit 112 may control a color temperature under control of at least one processor 111. At least one processor 111 may control a color temperature based on content. Specifically, when it is identified that content is output, at least one processor 111 may acquire frame-by-frame color information of content for which output is determined. At least one processor 111 may then control a color temperature based on the acquired frame-by-frame color information. At least one processor 111 may acquire at least one main color of a frame based on the frame-by-frame color information. At least one processor 111 may then adjust the color temperature based on at least one acquired main color. For example, a color temperature adjustment by at least one processor 111 may be classified into a warm type or a cold type. It is assumed that a frame to be output (hereinafter, an output frame) includes a scene in which a fire occurs. At least one processor 111 may identify (or acquire) that a main color is red based on color information included in a current output frame. At least one processor 111 may then identify a color temperature corresponding to the identified main color (red). The color temperature corresponding to red may be the warm type. At least one processor 111 may use an artificial intelligence model to acquire the color information or major color of a frame. According to various embodiments, the artificial intelligence model may be stored in the electronic apparatus 100 (e.g., the memory 113). According to another embodiment, the artificial intelligence model may be stored in an external server communicable with the electronic apparatus 100.

The memory 113 may be implemented as an internal memory such as a read-only memory (ROM) (e.g., an electrically erasable programmable read-only memory (EEPROM)) or a random access memory (RAM) included in at least one processor 111, or may be implemented as a memory separate from at least one processor 111. In this case, the memory 113 may be implemented as an embedded memory type embedded in the electronic apparatus 100 or as a detachable memory type detachable from the electronic apparatus 100 based on a data storage purpose. For example, data for driving the electronic apparatus 100 may be stored in the memory embedded in the electronic apparatus 100, and data for an extended function of the electronic apparatus 100 may be stored in the memory detachable from the electronic apparatus 100.

The memory embedded in the electronic apparatus 100 may be implemented as at least one of a volatile memory (e.g., a dynamic random access memory (DRAM), a static random access memory (SRAM), a synchronous dynamic random access memory (SDRAM)) or a non-volatile memory (e.g., a one time programmable read-only memory (OTPROM), a programmable read-only memory (PROM), an erasable and programmable read-only memory (EPROM), an electrically erasable and programmable read-only memory (EEPROM), a mask ROM, a flash ROM, a flash memory (e.g., a NAND flash or a NOR flash), a hard drive, or a solid state drive (SSD)); and the memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)), an external memory connectable to a universal serial bus (USB) port (e.g., a USB memory), or the like.

The memory 110 may store at least one instruction for the electronic apparatus 100. In addition, the memory 113 may store an operating system (OS) for driving the electronic apparatus 100. In addition, according to various embodiments of the present disclosure, the memory 113 may store various software programs or applications for operating the electronic apparatus 100. In addition, the memory 113 may include a semiconductor memory such as a flash memory (Flash Memory) or a magnetic storage medium such as a hard disk.

Specifically, the memory 113 may store various software modules for operating the electronic apparatus 100 according to various embodiments of the present disclosure, and at least one processor 111 may execute the various software modules stored in the memory 113 to control an operation of the electronic apparatus 100. That is, the memory 113 may be accessed by at least one processor 111, and at least one processor 111 may perform reading, writing, modification, deletion, update, or the like of data.

In the present disclosure, the term “memory 113” may be used to include a storage unit, a read-only memory (ROM), a random access memory (RAM) installed in at least one processor 111, or a memory card mounted in the electronic apparatus 100 (e.g., a micro secure digital (micro SD) card or a memory stick).

The communication interface 114 is a component for performing communication with various types of external devices by using various types of communication methods. The communication interface 114 may include a wireless communication module or a wired communication module. Each communication module may be implemented as at least one hardware chip.

The wireless communication module may be a module for performing communication with an external device in a wireless manner. For example, the wireless communication module may include at least one module selected from among a wireless fidelity (Wi-Fi) module, a Bluetooth module, an infrared communication module, or other communication modules.

The Wi-Fi module and the Bluetooth module may perform communication in a Wi-Fi manner and a Bluetooth manner, respectively. When the Wi-Fi module or the Bluetooth module is used, the communication interface 114 may first transmit and receive various connection information such as a service set identifier (SSID) or a session key, and then connect the communication based on the various connection information, and then transmit and receive various information.

The infrared communication module may perform communication based on infrared data association (IrDA) technology of transmitting data in a wireless manner at a short distance by using infrared rays between visible light and millimeter waves.

The other communication modules may include at least one communication chip that performs communication according to various wireless communication standards such as Zigbee, third generation (3G), third generation partnership project (3GPP), long term evolution (LTE), LTE advanced (LTE-A), fourth generation (4G), and fifth generation (5G), in addition to the above-described communication methods.

The wired communication module may be a module for performing communication with an external device in a wired manner. For example, the wired communication module may include at least one of a local area network (LAN) module, an Ethernet module, a pair cable, a coaxial cable, an optical fiber cable, or an ultrawideband (UWB) module.

The manipulation interface 115 may include various types of input devices. For example, the manipulation interface 115 may include a physical button. In this case, the physical button may include a function key, a direction key (e.g., a four-direction key), or a dial button. According to various embodiments, the physical button may be implemented as a plurality of keys. According to another embodiment, the physical button may be implemented as one key. When the physical button is implemented as one key, the electronic apparatus 100 may receive a user input in which one key is pressed for a threshold time or more. When the user input in which one key is pressed for the threshold time or more is received, at least one processor 111 may perform a function corresponding to the user input. For example, at least one processor 111 may provide an illumination function based on the user input.

The manipulation interface 115 may receive a user input by using a non-contact method. When a user input is received using a contact method, a physical force is required to be transmitted to the electronic apparatus 100. Accordingly, a control method of the electronic apparatus 100 regardless of physical force may be required. Specifically, the manipulation interface 115 may receive a user gesture and perform an operation corresponding to the received user gesture. The manipulation interface 115 may receive a user gesture from a sensor (e.g., an image sensor or an infrared sensor).

The manipulation interface 115 may receive a user input by using a touch method. For example, the manipulation interface 115 may receive a user input from a touch sensor. According to various embodiments, the touch method may be implemented in a non-contact manner. For example, the touch sensor may determine whether a user body approaches within a threshold distance. The touch sensor may identify a user input even when a user does not come into contact with the touch sensor. In another implementation example, the touch sensor may identify a user input in which a user comes into contact with the touch sensor.

In addition to the manipulation interface 115 described above, the electronic apparatus 100 may receive a user input in various ways. According to various embodiments, the electronic apparatus 100 may receive a user input through an external remote control device. The external remote control device may be a remote control device corresponding to the electronic apparatus 100 (e.g., a dedicated control device of the electronic apparatus 100) or a portable communication device of a user (e.g., a smartphone or a wearable device). An application for controlling the electronic apparatus 100 may be stored in the portable communication device. The portable communication device may acquire the user input from the stored application and transmit the acquired user input to the electronic apparatus 100. The electronic apparatus 100 may receive a user input from the portable communication device and perform an operation corresponding to a user control command.

The electronic apparatus 100 may receive a user input by using voice recognition. According to various embodiments, the electronic apparatus 100 may receive a user voice through a microphone included in the electronic apparatus 100. According to another embodiment, the electronic apparatus 100 may receive a user voice through a microphone or from an external device. Specifically, the external device may acquire the user voice through a microphone included in the external device and transmit the acquired user voice to the electronic apparatus 100. The user voice transmitted from the external device may be audio data or digital data acquired by converting the audio data (e.g., audio data converted into a frequency domain). The electronic apparatus 100 may perform an operation corresponding to the received user voice. Specifically, the electronic apparatus 100 may receive audio data corresponding to a user voice through a microphone. The electronic apparatus 100 may then convert the received audio data into digital data. The electronic apparatus 100 may then convert the converted digital data into text data by using a speech-to-text (STT) function. According to various embodiments, the electronic apparatus 100 may directly perform the speech-to-text (STT) function.

According to another embodiment, the external server may perform the speech-to-text (STT) function. The electronic apparatus 100 may transmit digital data to the external server. The external server may convert the digital data into text data and acquire control command data based on the converted text data. The external server may transmit the control command data to the electronic apparatus 100 (Here, the control command data may also include the text data). The electronic apparatus 100 may perform an operation corresponding to a user voice based on the acquired control command data.

The electronic apparatus 100 may provide a voice recognition function by using one assistant (or an artificial intelligence assistant, e.g., Bixby™), which is merely one of various embodiments, and provide the voice recognition function by using a plurality of assistants. In this case, the electronic apparatus 100 may provide the voice recognition function by selecting one of a plurality of assistants based on a trigger word corresponding to an assistant or a specific key included in a remote controller.

The electronic apparatus 100 may receive a user input by using screen interaction. The screen interaction may indicate a function for identifying whether a predetermined event occurs based on an image projected by the electronic apparatus 100 on a screen (or a projection surface) and acquiring the user input based on the predetermined event. The predetermined event may indicate an event in which a predetermined object is identified at a specific position (e.g., a position at which a user interface (UI) for receiving a user input is projected) at the specific position. The predetermined object may include at least one of a body part of a user (e.g., a finger), a pointer, or a laser point. When a predetermined object is identified at a position corresponding to the projected user interface (UI), the electronic apparatus 100 may identify that the user input for selecting the projected user interface (UI) is received. For example, the electronic apparatus 100 may project a guide image to display a user interface (UI) on a screen. The electronic apparatus 100 may then identify whether a user selects the projected user interface (UI). Specifically, when a predetermined event is identified at a position of a projected user interface (UI), the electronic apparatus 100 may identify that a user selects the projected user interface (UI). The projected user interface (UI) may include at least one item. To identify whether the predetermined event occurs at a position of the projected user interface (UI), the electronic apparatus 100 may perform spatial analysis. The electronic apparatus 100 may perform the spatial analysis by using a sensor (e.g., an image sensor, an infrared sensor, a depth camera, or a distance sensor). By performing the spatial analysis, the electronic apparatus 100 may identify whether the predetermined event occurs at the specific position (a position at which a user interface (UI) is projected). When it is identified that the predetermined event occurs at the specific position (the position at which the user interface (UI) is projected), the electronic apparatus 100 may then identify that the user input for selecting the user interface (UI) corresponding to the specific position is received.

The input/output interface 116 is a component for inputting/outputting at least one of an audio signal or an image signal. The input/output interface 116 may receive at least one of an audio signal or an image signal from an external device and may output a control command to the external device.

In an implementation example, the input/output interface 116 may be implemented as including an interface for inputting/outputting only an audio signal and an interface for inputting/outputting only an image signal, or may be implemented as one interface for inputting/outputting both an audio signal and an image signal.

According to various embodiments of the present disclosure, the input/output interface 116 may be implemented as at least one of wired input/output interfaces such as a high definition multimedia interface (HDMI), a mobile high-definition link (MHL), a universal serial bus (USB), a USB C-type, a DisplayPort (DP), Thunderbolt, a video graphics array (VGA) port, a red-green-blue (RGB) port, a D-subminiature (D-SUB), or a digital visual interface (DVI). According to various embodiments, the wired input/output interface may be implemented as including an interface for inputting/outputting only an audio signal and an interface for inputting/outputting only an image signal, or may be implemented as one interface for inputting/outputting both an audio signal and an image signal.

The electronic apparatus 100 may receive data through the wired input/output interface, which is merely one of various embodiments, and power may be supplied through the wired input/output interface. For example, the electronic apparatus 100 may receive power from an external battery through a USB C-type or from a power outlet through a power adapter. In another example, the electronic apparatus 100 may receive power from an external device (e.g., a laptop or a monitor) through a display port (DP).

An audio signal may be implemented to be input through a wired input/output interface and an image signal may be implemented to be input through a wireless input/output interface (or a communication interface). Alternatively, an audio signal may be implemented to be input through a wireless input/output interface (or a communication interface) and an image signal may be implemented to be input through a wired input/output interface.

The speaker 117 is a component for outputting an audio signal. In particular, the speaker 117 may include an audio output mixer, an audio signal processor, and an acoustic output module. The audio output mixer may synthesize a plurality of audio signals to be output into at least one audio signal. For example, the audio output mixer may synthesize an analog audio signal and another analog audio signal (e.g., an analog audio signal received from an external source) into at least one analog audio signal. The acoustic output module may include a speaker or an output terminal. According to various embodiments, the acoustic output module may include a plurality of speakers, and in this case, the acoustic output module may be disposed in a body, and audio emitted by covering at least a portion of a diaphragm of the acoustic output module may be transmitted to the outside of the body through a waveguide. The acoustic output module may include a plurality of acoustic output units, and as the plurality of acoustic output units are symmetrically arranged on an exterior of the body, audio may be emitted in all directions, that is, in a 360-degree omnidirectional manner.

The microphone 118 is a component for receiving a user voice or other sounds and converting the same into audio data. The microphone 118 may receive a user voice when activated. For example, the microphone 118 may be integrally formed on an upper side, a front side, or a side direction, or the like of the electronic apparatus 100. The microphone 118 may include various configurations such as a microphone for collecting a user voice in an analog form, an amplifier circuit for amplifying the collected user voice, an analog-to-digital (A/D) conversion circuit for sampling the amplified user voice and converting the amplified user voice into a digital signal, and a filter circuit for remove a noise component from the converted digital signal.

The power unit 119 may receive power from an external source and supply power to various components of the electronic apparatus 100. According to various embodiments of the present disclosure, the power unit 119 may receive power by using various methods. According to various embodiments, the power unit 119 may receive power by using a connector 130 as illustrated in FIG. 1. The power unit 119 may receive power by using a direct current (DC) power cord of 220 V. However, the present disclosure is not limited thereto, and the electronic apparatus 100 may receive power by using a universal serial bus (USB) power cord or may receive power by using a wireless charging method.

The power unit 119 may receive power from an internal battery or an external battery. According to various embodiments of the present disclosure, the power unit 119 may receive power from the internal battery. For example, the power unit 119 may charge power of the internal battery by using at least one of a direct current (DC) power cord of 220 V, a universal serial bus (USB) power cord, or a USB C-type power cord, and may receive power from the charged internal battery. According to various embodiments of the present disclosure, the power unit 119 may receive power from the external battery. For example, when the electronic apparatus 100 and the external battery are connected to each other by using various wired communication methods such as a universal serial bus (USB) power cord, a USB C-type power cord, and a socket groove, the power unit 119 may receive power from the external battery. That is, the power unit 119 may receive power directly from the external battery, or may charge the internal battery by using the external battery and receive power from the charged internal battery.

The power unit 119 according to the present disclosure may receive power by using at least at least one of the plurality of power supply methods described above.

In relation to power consumption, the electronic apparatus 100 may have power consumption equal to or lower than a predetermined value (e.g., 43 W) due to a socket type, another standard, or the like. In this case, the electronic apparatus 100 may vary power consumption to reduce power consumption when a battery is used. That is, the electronic apparatus 100 may vary power consumption based on a power supply method, a power usage amount, or the like.

The driving unit 120 may drive at least one hardware component included in the electronic apparatus 100. The driving unit 120 may generate a physical force and may transmit the physical force to at least one hardware component included in the electronic apparatus 100.

The driving unit 120 may generate driving power for movement of a hardware component included in the electronic apparatus 100 (e.g., movement of the electronic apparatus 100) or rotation of a component (e.g., rotation of a projection lens).

The driving unit 120 may adjust the projection angle of the projection unit 112. The driving unit 120 may move a position of the electronic apparatus 100. The driving unit 120 may control a movement member to move the electronic apparatus 100. For example, the driving unit 120 may control the movement member by using a motor.

The sensor unit 121 may include at least one sensor. Specifically, the sensor unit 121 may include at least one of a tilt sensor for sensing a tilt of the electronic apparatus 100 or an image sensor for capturing an image. The tilt sensor may indicate an acceleration sensor or a gyro sensor, and the image sensor may indicate a camera or a depth camera. The tilt sensor may be described as a movement sensor. The sensor unit 121 may include various sensors in addition to the tilt sensor or the image sensor. For example, the sensor unit 121 may include an illuminance sensor or a distance sensor. The distance sensor may be a time of flight (ToF). The sensor unit 121 may include a light detection and ranging (LiDAR) sensor.

The electronic apparatus 100 may control an illumination function in conjunction with an external device. Specifically, the electronic apparatus 100 may receive illumination information from an external device. The illumination information may include at least one of brightness information or color temperature information set by the external device. The external device may indicate a device connected to the same network as the electronic apparatus 100 (e.g., an internet of things (IoT) device included in the same home/company network) or a device communicable with the electronic apparatus 100 even though the device is not included in the same network as the electronic apparatus 100 (e.g., a remote control server). For example, it is assumed that an external illumination device (an IoT device) included in the same network as the electronic apparatus 100 outputs red illumination at brightness of 50. The external illumination device (the IoT device) may directly or indirectly transmit illumination information (e.g., information indicating that red illumination is output at brightness of 50) to the electronic apparatus 100. The electronic apparatus 100 may control output of a light source based on the illumination information received from the external illumination device. For example, when the illumination information received from the external illumination device includes information indicating that red illumination is output at brightness of 50, the electronic apparatus 100 may output red illumination at brightness of 50.

The electronic apparatus 100 may control an illumination function based on biometric information. Specifically, at least one processor 111 may acquire biometric information of a user. The biometric information may include at least one of the body temperature, heart rate, blood pressure, respiration, or electrocardiogram of the user. The biometric information may include various information in addition to the above-described information. For example, the electronic apparatus 100 may include a sensor for measuring biometric information. At least one processor 111 may acquire biometric information of the user form the sensor and control output of a light source based on the acquired biometric information. In another example, at least one processor 111 may receive biometric information from an external device through the input/output interface 116. The external device may indicate a portable communication device of the user (e.g., a smartphone or a wearable device). At least one processor 111 may acquire biometric information of the user from the external device and may control output of a light source based on the acquired biometric information. In an implementation example, the electronic apparatus 100 may identify whether the user is sleeping, and when it is identified that the user is sleeping (or preparing to sleep), at least one processor 111 may control output of a light source based on biometric information of the user.

The electronic apparatus 100 according to various embodiments of the present disclosure may provide various smart functions.

Specifically, the electronic apparatus 100 may be connected to a portable terminal device for controlling the electronic apparatus 100, and a screen output from the electronic apparatus 100 may be controlled through a user input that is input from the portable terminal device. For example, the portable terminal device may be implemented as a smartphone including a touch display, and the electronic apparatus 100 may receive screen data provided from the portable terminal device from the portable terminal device and output the screen data, and a screen output from the electronic apparatus 100 may be controlled based on a user input that is input from the portable terminal device.

The electronic apparatus 100 may share content or music provided from the portable terminal device by performing connection with the portable terminal device by using various communication methods such as Miracast, airplay, wireless desktop experience (DEX), or a remote personal computer (remote PC) method.

In addition, the portable terminal device and the electronic apparatus 100 may be connected to each other by various connection methods. According to various embodiments, the portable terminal device may search for the electronic apparatus 100 and perform a wireless connection, or the electronic apparatus 100 may search for the portable terminal device and perform the wireless connection. In addition, the electronic apparatus 100 may output content provided from the portable terminal device.

According to various embodiments, when a predetermined gesture is detected (e.g., a motion tap view) through a display of the portable terminal device after placing the portable terminal device near the electronic apparatus 100 in a state in which specific content or music is being output from the portable terminal device, the electronic apparatus 100 may output the content or music being output from the portable terminal device.

According to various embodiments, when the portable terminal device becomes close to the electronic apparatus 100 at a predetermined distance or less (e.g., a non-contact tap view) or when the portable terminal device is brought into contact with the electronic apparatus 100 twice at a short interval (e.g., a contact tap view) in a state in which specific content or music is being output from the portable terminal device, the electronic apparatus 100 may output the content or music being output from the portable terminal device.

In the above-described embodiments, it is described that the same screen as a screen provided from the portable terminal device is provided from the electronic apparatus 100, and however, the present disclosure is not limited thereto. That is, when a connection between the portable terminal device and the electronic apparatus 100 is established, the portable terminal device may output a first screen provided from the portable terminal device, and the electronic apparatus 100 may output a second screen provided from the portable terminal device, which is different from the first screen. For example, the first screen may be implemented as a screen provided from a first application installed in the portable terminal device, and the second screen may be implemented as a screen provided from a second application installed in the portable terminal device. For example, the first screen and the second screen may be different screens provided from one application installed in the portable terminal device. For example, the first screen may be a screen including a remote controller-type UI for controlling the second screen.

The electronic apparatus 100 according to the present disclosure may output a standby screen. For example, the electronic apparatus 100 may output a standby screen when the electronic apparatus 100 is not connected to the external device or when no input is received from the external device for a predetermined time. A condition for the electronic apparatus 100 to output a standby screen is not limited to the above-described example, and a standby screen may be output based on various conditions.

The electronic apparatus 100 may output a standby screen in a blue-screen form, and the present disclosure is not limited thereto. For example, the electronic apparatus 100 may acquire a non-standard object by extracting only a shape of a specific object from data received from the external device, and output a standby screen including the acquired non-standard object.

The electronic apparatus 100 may further include a display.

The display may be implemented as various types of displays such as a liquid crystal display (LCD), an organic light-emitting diodes (OLED) display, and a plasma display panel (PDP). In the display, a driving circuit implemented in a form such as an amorphous silicon thin film transistor (a-si TFT), a low temperature poly silicon thin film transistor (LTPS TFT), or an organic thin film transistor (OTFT), a backlight unit, or the like, may also be included together. The display may be implemented as a touch screen combined with a touch sensor, a flexible display, a three-dimensional display (3D display), or the like. According to various embodiments of the present disclosure, the display may include not only a display panel for outputting the image, but also a bezel for housing the display panel. In particular, according to various embodiments of the present disclosure, the bezel may include a touch sensor for sensing a user interaction.

The electronic apparatus 100 may further include a shutter unit.

The shutter unit may include at least one of a shutter, a fixing member, a rail, or a body.

The shutter may block light output from the projection unit 112. The fixing member may fix a position of the shutter. The rail may serve as a path for moving the shutter and the fixing member. The body may be a component including the shutter and the fixing member.

The movement member 122 may indicate a member for moving the electronic apparatus 10 from a first position to a second position in a space in which the electronic apparatus 100 is disposed. The electronic apparatus 100 may control the movement member 122 to move the electronic apparatus 100 by using a force generated by the driving unit 120. The electronic apparatus 100 may generate a force to be transmitted to the movement member 122 by using a motor included in the driving unit 120.

The movement member 122 may include at least one wheel (e.g., a circular wheel). The electronic apparatus 100 may move to a target position (or a goal position) by using the movement member. When a user input or a control command is received, the electronic apparatus 100 may rotate the movement member by transmitting a force generated by a motor to the movement member. The electronic apparatus 100 may control the movement member to adjust a rotation speed, a rotation direction, or the like. The electronic apparatus 100 may perform a movement operation (or a movement function) by controlling the movement member based on the target position or a travel direction, or the like.

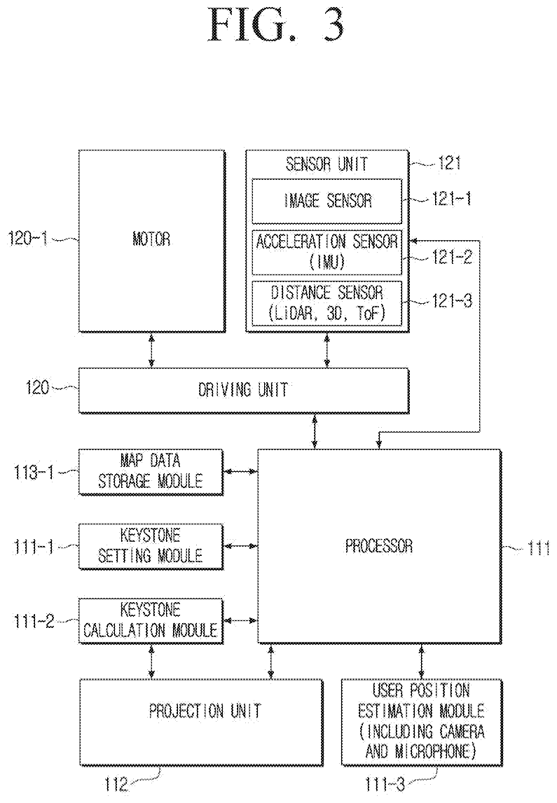

FIG. 3 is a block diagram illustrating at least one module included in the electronic apparatus 100 according to an embodiment.

The electronic apparatus 100 may include at least one of the driving unit 120, a motor 120-1, a sensor unit 121, at least one processor 111, a keystone setting module 111-1, a keystone calculation module 111-2, a user position estimation module 111-3, the projection unit 112, or a map data storage module 113-1. Overall operations of the electronic apparatus 100 may be controlled by at least one processor 111.

At least one processor 111 may control the motor 120-1 by using the driving unit 120. At least one processor 111 may control the motor 120-1 to rotate or stop by using the driving unit 120.

For example, at least one processor 111 may control the sensor unit 121 by using the driving unit 120.

The sensor unit 121 may include at least one of an image sensor 121-1, an acceleration sensor 121-2, or a distance sensor 121-3.

The image sensor 121-1 may include a camera. Sensing data acquired by the image sensor 121-1 may include a captured image.

The acceleration sensor 121-2 may sense an acceleration of the electronic apparatus 100. The acceleration sensor 121-2 may include an inertial measurement unit (IMU) sensor.

The distance sensor 121-3 may sense distance information related to an environment around the electronic apparatus 100. For example, the electronic apparatus 100 may sense distance information from the electronic apparatus 100 to a specific object by using the distance sensor 121-3. The distance sensor 121-3 may include at least one of a light detection and ranging (LiDAR) sensor, a three-dimensional (3D) sensor, or a time of flight (ToF) sensor.

For example, at least one processor 111 may directly control the sensor unit 121 without passing through the driving unit 120.

Sensing data acquired from the sensor unit 121 may be transmitted to at least one processor 111. At least one processor 111 may acquire sensing data acquired from the sensor unit 121.

When a user command for outputting a projection image is received, at least one processor 111 may request map data from the map data storage module 113-1. At least one processor 111 may receive, from the map data storage module 113-1, map data related to a space in which the electronic apparatus 100 is currently positioned.

At least one processor 111 may identify the projection surface position determined (or predetermined) by a user based on the map data. At least one processor 111 may determine a projection position in consideration of the projection surface position and resolution information (or size information) of a projection image. At least one processor 111 may perform the keystone correction based on the projection surface position and a projection position.

At least one processor 111 may request, from the keystone setting module 111-1, information required for the keystone correction. At least one processor 111 may acquire keystone correction information required for the keystone correction from the keystone setting module 111-1.

At least one processor 111 may perform the keystone correction based on the projection surface position, resolution information of a projection image, a projection position, and the keystone correction information acquired from the keystone setting module 111-1. At least one processor 111 may perform the keystone correction by using the keystone calculation module 111-2. At least one processor 111 may transmit, to the keystone calculation module 111-2, the projection surface position, the resolution information of the projection image, the projection position, and the keystone correction information acquired from the keystone setting module 111-1.

The keystone calculation module 111-2 may generate a projection image on which the keystone correction is performed based on the projection surface position, the resolution information of the projection image, the projection position, and the keystone correction information. The keystone calculation module 111-2 may transmit the projection image on which the keystone correction is performed to the projection unit 112.

At least one processor 111 may control the projection unit 112 to output the projection image on which the keystone correction is performed.

According to various embodiments, at least one processor 111 may identify a user position by using the user position estimation module 111-3. At least one processor 111 may identify a user position by using the user position estimation module 111-3. The user position estimation module 111-3 may identify the user position by using a camera or a microphone.

For example, at least one processor 111 may identify a user position based on a captured image acquired through a camera.

For example, at least one processor 111 may identify a user position based on recorded audio acquired through a microphone. For example, at least one processor 111 may record audio in real time through two microphones. At least one processor 111 may identify a user position based on two audio simultaneously recorded and two microphone positions.

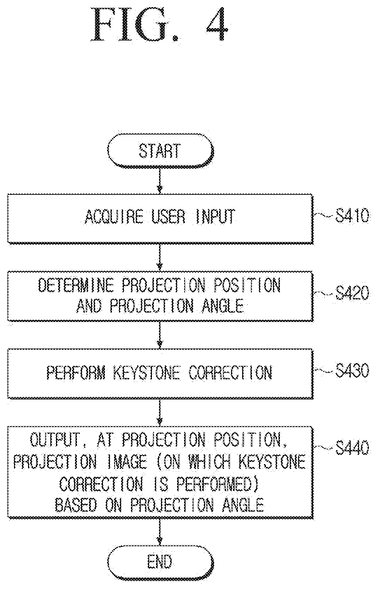

FIG. 4 is a diagram illustrating an operation of outputting a projection image by performing the keystone correction according to an embodiment.

Referring to FIG. 4, the electronic apparatus 100 may acquire a user input (S410). The user input may include a command for outputting a projection image. The user input may be described as a projection command, a user command, or the like.

The electronic apparatus 100 may determine a projection position and the projection angle based on the user input (S420). The projection position may indicate a position at which the electronic apparatus 100 outputs a projection image. The projection angle may indicate a direction in which the electronic apparatus 100 outputs a projection image at the projection position. The projection angle may be determined based on the projection surface position. The electronic apparatus 100 may output a projection image onto the projection surface position selected (or designated) by a user. The electronic apparatus 100 may determine the projection angle based on a projection position and the projection surface position.

The electronic apparatus 100 may perform the keystone correction on a projection image to be output at the projection position (S430).

The electronic apparatus 100 may output, at the projection position, the projection image on which the keystone correction is performed based on the projection angle (S440). The electronic apparatus 100 may move from a current position to the projection position.

For example, the keystone correction may be performed before movement of the electronic apparatus 100.

For example, the keystone correction may be performed during the movement of the electronic apparatus 100.

For example, the keystone correction may be performed after movement of the electronic apparatus 100.

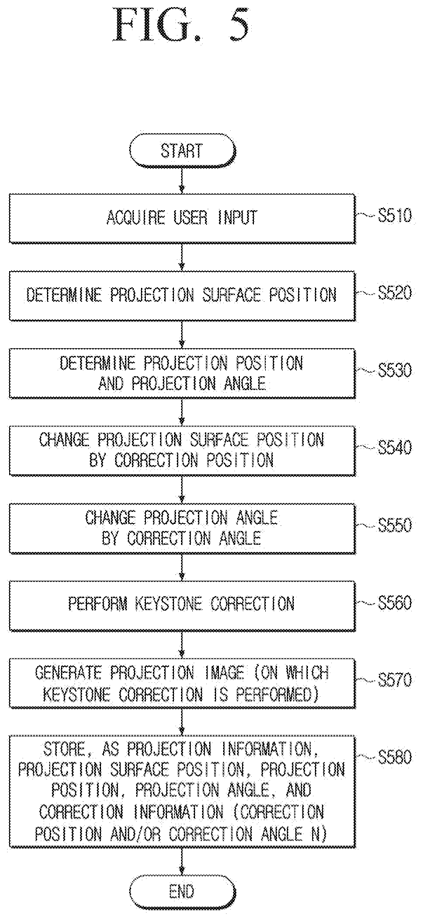

FIG. 5 is a diagram illustrating an operation of storing projection information according to an embodiment.

Referring to FIG. 5, the electronic apparatus 100 may acquire a user input (S510). The user input may include a command for outputting a projection image to a specific projection surface.

The electronic apparatus 100 may determine the projection surface position (S520). When a user input is acquired, the electronic apparatus 100 may determine the projection surface position corresponding to the user input.

For example, the projection surface position may be selected by a user. The electronic apparatus 100 may acquire the projection surface position based on a projection surface selected by the user.

For example, the projection surface position may be a predetermined position. The electronic apparatus 100 may determine the predetermined position as the projection surface position. The predetermined position may be a fixed position. The predetermined position may be a position at which a recent projection image is output.

The electronic apparatus 100 may determine a projection position and the projection angle (S530). The electronic apparatus 100 may determine a projection position based on the projection surface position. The electronic apparatus 100 may determine, as the projection position, a position apart by a predetermined distance from the projection surface position. The electronic apparatus 100 may acquire map data. The electronic apparatus 100 may identify the projection surface position based on the map data. The map data may include coordinate information of a space in which the electronic apparatus 100 is positioned.

The electronic apparatus 100 may identify the projection surface position from the map data and may determine, as the projection position, a position apart by the predetermined distance from the identified the projection surface position. When a plurality of projection positions are present, the plurality of projection positions may be described as candidate projection positions. The electronic apparatus 100 may determine one of the plurality of candidate projection positions as a final projection position.

The electronic apparatus 100 may determine the projection angle for outputting a projection image to the determined the projection surface position. The electronic apparatus 100 may acquire (or calculate) a distance between the projection surface position and the projection position. The electronic apparatus 100 may determine the projection angle for outputting a projection image onto the projection surface position.

For example, the projection surface position and the projection position may be defined as coordinates on an x-axis and a y-axis (in a two-dimensional space).

For example, the projection surface position and the projection position may be defined as coordinates on an x-axis, a y-axis, and a z-axis (in a three-dimensional space).

For example, the projection angle may be defined in terms of roll, pitch, and yaw. A description thereof is provided with reference to FIG. 13.

The electronic apparatus 100 may acquire correction information. The correction information may include at least one of the correction position or the correction angle. The correction position may include information for correcting the projection surface position. The correction angle may include information for correcting the projection angle.

The electronic apparatus 100 may change the projection surface position based on the correction position (S540). The electronic apparatus 100 may correct the projection surface position by changing the projection surface position by the correction position. The electronic apparatus 100 may change the projection surface position from a first projection surface position to a second projection surface position based on the correction position.

The electronic apparatus 100 may change the projection angle based on the correction angle (S550). The electronic apparatus 100 may correct the correction angle by changing the projection angle by the correction angle. The electronic apparatus 100 may change the projection angle from a first projection angle to a second projection angle based on the correction angle.

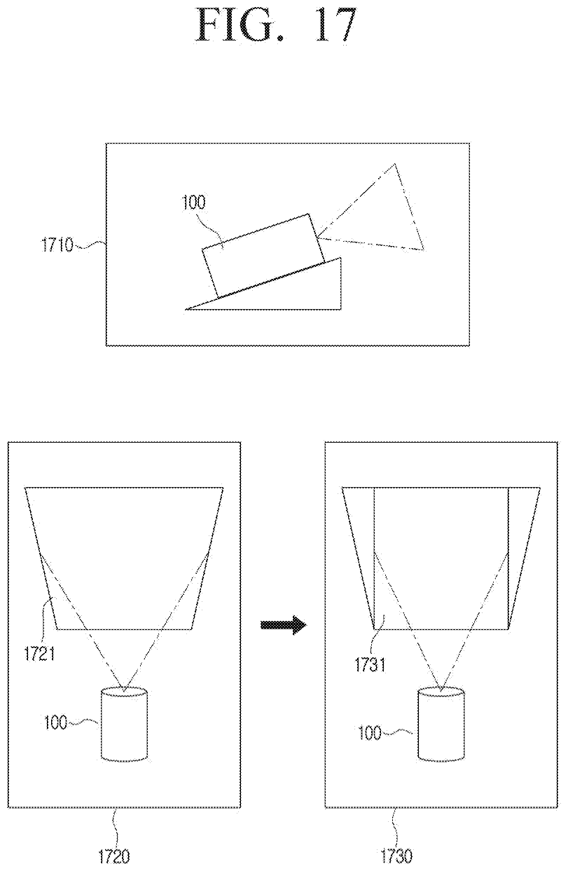

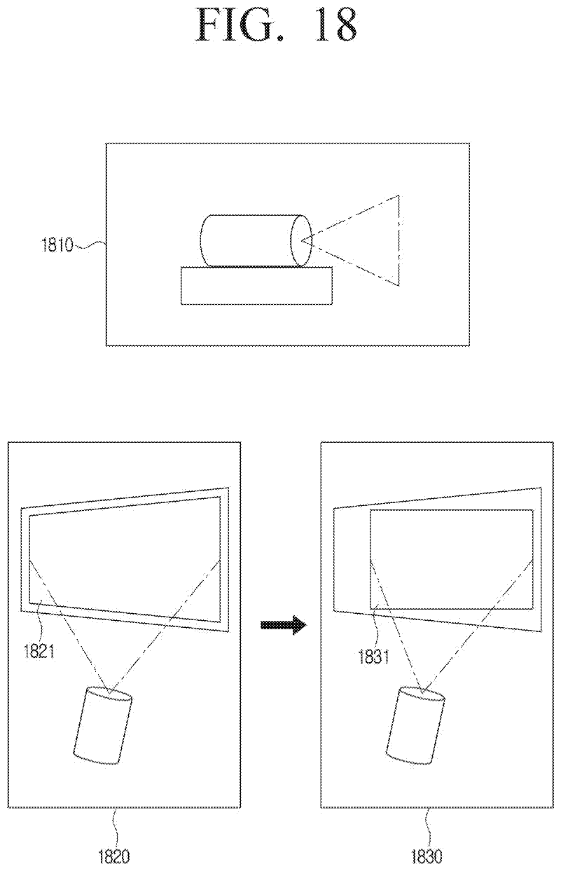

The electronic apparatus 100 may perform the keystone correction based on the projection surface position, the projection position, and the projection angle (S560). A detailed description of the keystone correction is provided with reference to FIGS. 17 and 18. The electronic apparatus 100 may generate a projection image on which the keystone correction is performed (S570).

The electronic apparatus 100 may store, as projection information, the projection surface position, the projection position, the projection angle, and the correction information (S580). The electronic apparatus 100 may store the projection information in the memory 113. The memory 113 may store history information related to a projection history. The history information may include at least one projection information.

For example, when outputting a projection image to a first projection surface, the electronic apparatus 100 may acquire, as projection information, a first projection surface position, a first projection position, a first projection angle, correction information, and the like used for outputting the projection image. The history information may store a plurality of projection information. When projection images are output to three projection surfaces, the history information may include three projection information.

According to various embodiments, an operation of correcting the projection angle may be omitted. An operation of storing a correction for the projection angle or an operation of performing correction for the projection angle may be omitted.

FIG. 6 is a diagram illustrating an operation of identifying projection information corresponding to a projection surface according to an embodiment.

Steps S610, S620, and S630 of FIG. 6 may correspond to steps S510, S520, and S530 of FIG. 5. Redundant descriptions thereof are thus omitted.

The electronic apparatus 100 may identify projection information corresponding to the determined projection surface (S640). The electronic apparatus 100 may identify, among a plurality of projection information stored in the memory 113, projection information corresponding to the determined projection surface. The plurality of projection information may be included in the history information. The history information may be stored in the memory 113.

The history information may include separate projection information for each projection surface. For example, the history information may include first projection information for a first projection surface and second projection information for a second projection surface. When it is identified that a projection image is output to the first projection surface, the electronic apparatus 100 may acquire (or identify) the first projection information corresponding to the first projection surface.

When projection information corresponding to the determined projection surface is not identified (S640-N), the electronic apparatus 100 may perform the keystone correction based on at least one of the projection surface position, the projection position, or the projection angle (S650). The electronic apparatus 100 may directly perform the keystone correction without correction.

When projection information corresponding to the determined projection surface is identified (S640-Y), the electronic apparatus 100 may acquire correction information corresponding to the projection surface position (S660). The electronic apparatus 100 may identify projection information corresponding to the projection surface position and may acquire projection information included in the identified projection information.

The electronic apparatus 100 may perform the keystone correction based on at least one of the projection surface position, the projection position, the projection angle, or the correction information (S670). Unlike in step S650, the electronic apparatus 100 may perform the keystone correction based additionally on the correction information.

The electronic apparatus 100 may generate a projection image on which the keystone correction is performed based on a result of performing the keystone correction (S680). The electronic apparatus 100 may acquire the projection image on which the keystone correction is performed. The electronic apparatus 100 may store the acquired projection image in the memory 113. The electronic apparatus 100 may control the projection unit 112 to output a projection image based on a predetermined event.

The predetermined event may include at least one of an event in which the electronic apparatus 100 arrives at the projection position, or an event in which the keystone correction is performed.

FIG. 7 is a diagram illustrating a detailed operation of identifying projection information corresponding to a projection surface according to an embodiment.

Referring to FIG. 7, the electronic apparatus 100 may store, in the memory 113, first projection information including a first projection surface position, a first projection position, a first projection angle, or first correction information (S705). The electronic apparatus 100 may store the first projection information in history information included in the memory 113. Step S705 may indicate an operation in which a projection history is automatically stored when a projection image is output to a specific projection surface (a first projection surface).

It is assumed that a user command for outputting a projection image is received in a state in which the first projection information is stored.

The electronic apparatus 100 may determine at least one of a second projection surface position, a second projection position, or a second projection angle based on the user command (or a user input) (S706).

The electronic apparatus 100 may identify whether the first projection surface position corresponds to the second projection surface position (S740). The electronic apparatus 100 may compare the first projection surface position and the second projection surface position. The electronic apparatus 100 may acquire coordinate information indicating the first projection surface position. The electronic apparatus 100 may acquire coordinate information indicating the second projection surface position.

The electronic apparatus 100 may acquire a first difference value between an x-coordinate of the first projection surface position and an x-coordinate of the second projection surface position. The electronic apparatus 100 may identify whether the first difference value is less than a threshold value.

The electronic apparatus 100 may acquire a second difference value between a y-coordinate of the first projection surface position and a y-coordinate of the second projection surface position. The electronic apparatus 100 may identify whether the second difference value is less than the threshold value.

The electronic apparatus 100 may acquire a third difference value between a z-coordinate of the first projection surface position and a z-coordinate of the second projection surface position. The electronic apparatus 100 may identify whether the third difference value is less than the threshold value.

It is assumed that the projection surface position is defined in a two-dimensional coordinate system (an x-coordinate, a y-coordinate).

When the first difference value and the second difference value are less than the threshold value, the electronic apparatus 100 may identify that the first projection surface position corresponds to the second projection surface position.

It is assumed that the projection surface position is defined in a three-dimensional coordinate system (an x-coordinate, a y-coordinate, a z-coordinate).

When the first difference value and the third difference value are less than the threshold value, the electronic apparatus 100 may identify that the first projection surface position corresponds to the second projection surface position.

When the second difference value and the third difference value are less than the threshold value, the electronic apparatus 100 may identify that the first projection surface position corresponds to the second projection surface position.

When the first projection surface position does not correspond to the second projection surface position (S740-N), the electronic apparatus 100 may perform the keystone correction based on at least one of the second projection surface position, the second projection position, or the second projection angle (S750).

When the first projection surface position corresponds to the second projection surface position (S740-Y), the electronic apparatus 100 may acquire the first correction information corresponding to the second projection surface position (S760).

The electronic apparatus 100 may perform the keystone correction based on at least one of the second projection surface position, the second projection position, the second projection angle, or the first correction information (S770).

The electronic apparatus 100 may generate (or acquire) a projection image on which the keystone correction is performed (S780).

FIG. 8 is a diagram illustrating an operation of comparing projection directions according to an embodiment.

Referring to FIG. 8, the electronic apparatus 100 may store first correction information related to a first projection surface (S840). When outputting a projection image to the first projection surface, the electronic apparatus 100 may store information related to the first projection surface as first projection information. Correction information used for the first projection surface may be stored as the first correction information, and the first correction information may be included in the first projection information.

The electronic apparatus 100 may determine a second projection surface based on a user command (S860). The electronic apparatus 100 may determine a second projection surface for outputting a projection image based on the user command.

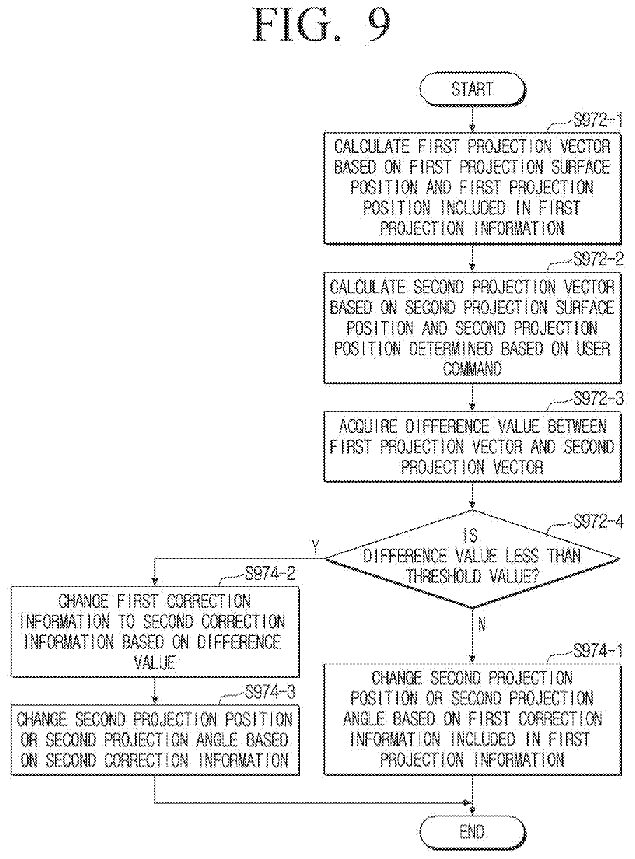

The electronic apparatus 100 may acquire a first projection direction for the first projection surface and a second projection direction for the second projection surface (S871). The electronic apparatus 100 may identify whether the first projection direction corresponds to the second projection direction (S872). Whether the first projection direction corresponds to the second projection direction may be determined based on a direction in which a projection image is output. A detailed operation thereof is provided with reference to FIGS. 9, 20, 21, and 22.

When the first projection direction corresponds to the second projection direction (S872-Y), the electronic apparatus 100 may perform the keystone correction based on at least one of the second projection surface position, the second projection position, the second projection angle, or the first correction information (S873).

When the first projection direction does not correspond to the second projection direction (S872-N), the electronic apparatus 100 may change the first correction information to second correction information based on a difference between the projection directions (S874). The electronic apparatus 100 may change the first correction information for the first projection surface to the second correction information based on a difference value between the projection directions. The difference value between the projection directions may indicate a difference value between the first projection direction and the second projection direction.

The electronic apparatus 100 may perform the keystone correction based on at least one of the second projection surface position, the second projection position, the second projection angle, or the second correction information (S875).

The electronic apparatus 100 may generate (or acquire) a projection image on which the keystone correction is performed (S880).

FIG. 9 is a diagram illustrating a detailed operation of comparing projection directions according to an embodiment.

Embodiment of FIG. 9 may specify steps S872 and S874 of FIG. 8.

The electronic apparatus 100 may calculate a first projection vector based on a first projection surface position and a first projection position included in the first projection information (S972-1). The electronic apparatus 100 may acquire the first projection vector indicating a vector from the first projection position to the first projection surface position.

The electronic apparatus 100 may calculate a second projection vector based on a second projection surface position and a second projection position determined based on a user command (or a user input) (S972-2). The electronic apparatus 100 may acquire the second projection vector indicating a vector from the second projection position to the second projection surface position.

The electronic apparatus 100 may acquire a difference value between the first projection vector and the second projection vector (S972-3). The electronic apparatus 100 may identify whether the difference value is less than a threshold value (S972-4).

For example, the electronic apparatus 100 may acquire a difference value of each vector component and may determine whether the difference value of each vector component is less than the threshold value.

For example, the electronic apparatus 100 may convert a vector component into a representative value (or an absolute value) indicating the vector component as one value. The electronic apparatus 100 may acquire a difference value between a first representative value indicating the first projection vector and a second representative value indicating the second projection vector. The electronic apparatus 100 may determine whether the difference value between the first representative value and the second representative value is less than the threshold value.

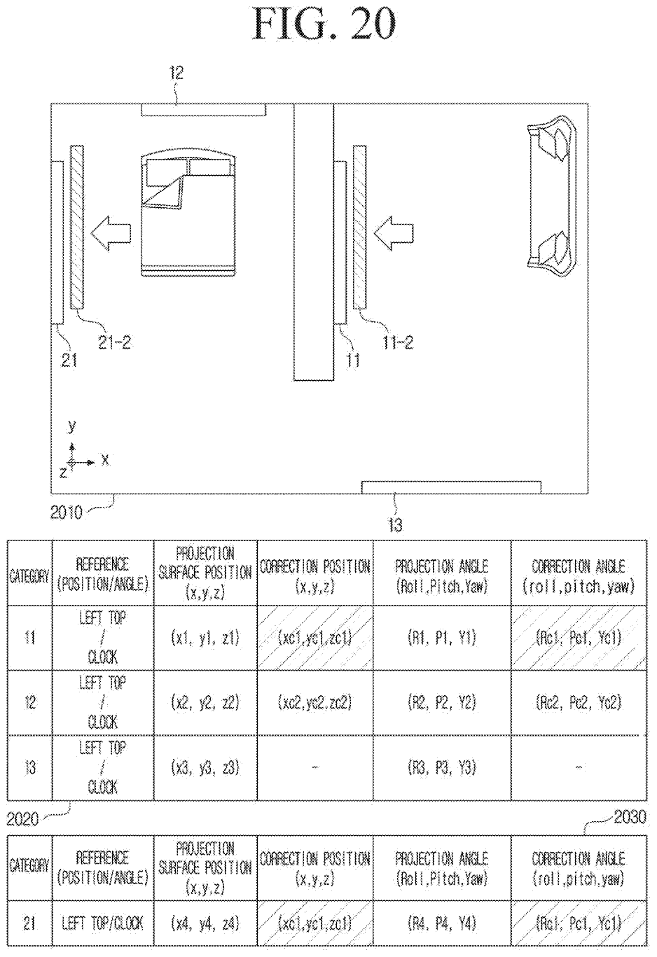

When the difference value is less than the threshold value (S972-4-Y), the electronic apparatus 100 may change at least one of the second projection position or the second projection angle based on the first correction information included in the first projection information (S974-1). A description thereof is provided with reference to FIG. 20.

When the difference value is not less than the threshold value (S972-4-N), the electronic apparatus 100 may change the first correction information to the second correction information based on the difference value (S974-2).

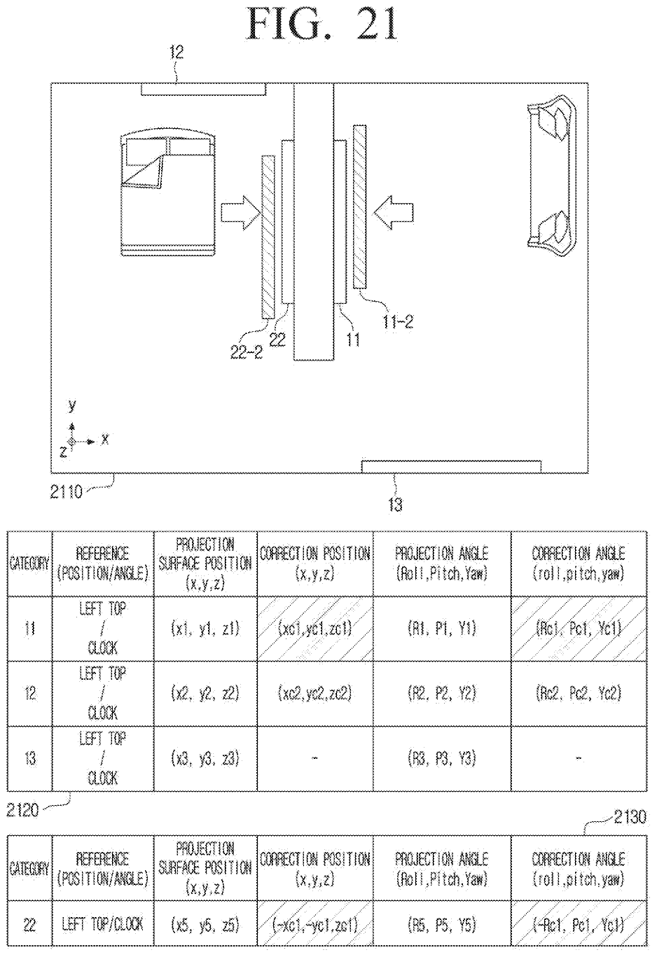

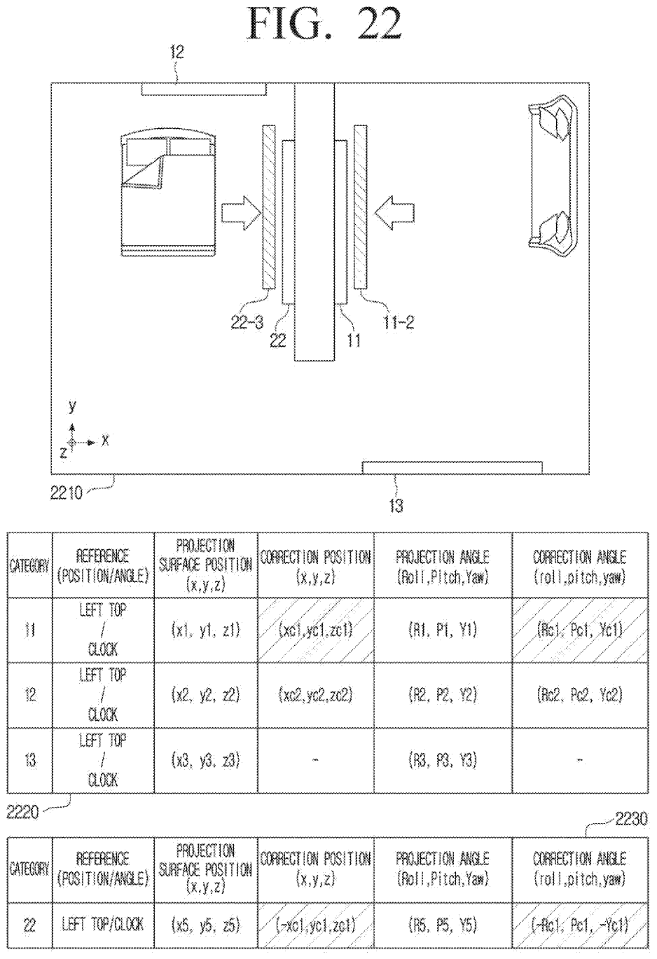

The electronic apparatus 100 may change at least one of the second projection position or the second projection angle based on the second correction information (S974-3). A description thereof is provided with reference to FIGS. 21 and 22.

The projection vector may be a difference vector. A reference point (a start position) of the difference vector may be the projection position.

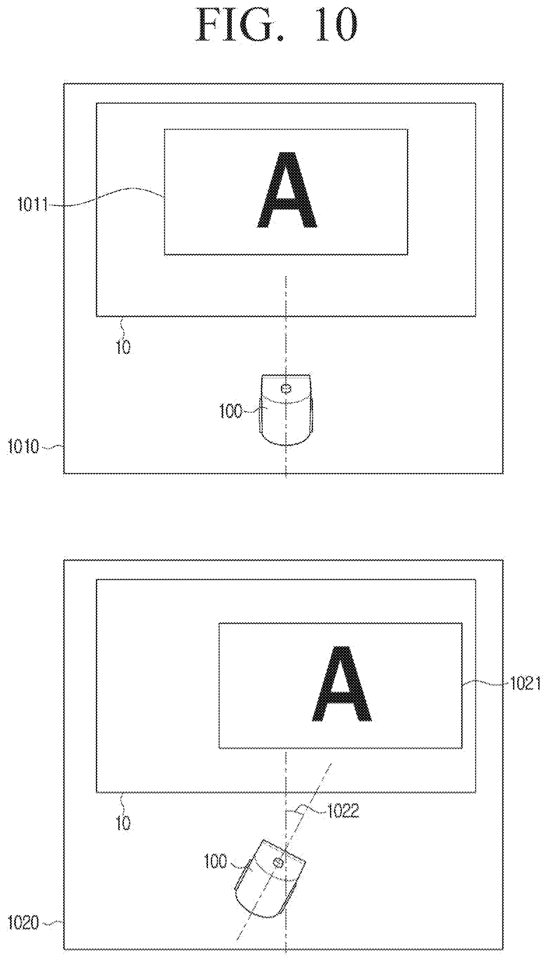

FIG. 10 is a diagram illustrating a horizontal tilt according to an embodiment.

Referring to FIG. 10, according to Embodiment 1010, the electronic apparatus 100 may output a projection image 1011 onto a projection surface 10 in a horizontal projection direction. It is assumed that the horizontal tilt is zero. The horizontal tilt may indicate a degree to which the electronic apparatus 100 is tilted to the left or the right toward the front.

According to Embodiment 1020, the electronic apparatus 100 may output a projection image 1021 onto the projection surface 10 in the horizontal projection direction. It is assumed that a horizontal tilt 1022 is 30 degrees. When the horizontal tilt is 30 degrees to the right, the electronic apparatus 100 may output the projection image 1021 onto the projection surface 10 to the right by 30 degrees.

The horizontal tilt may indicate a rotation angle (yaw) based on a z-axis illustrated in FIG. 13. The horizontal tilt may be described as a yaw angle.

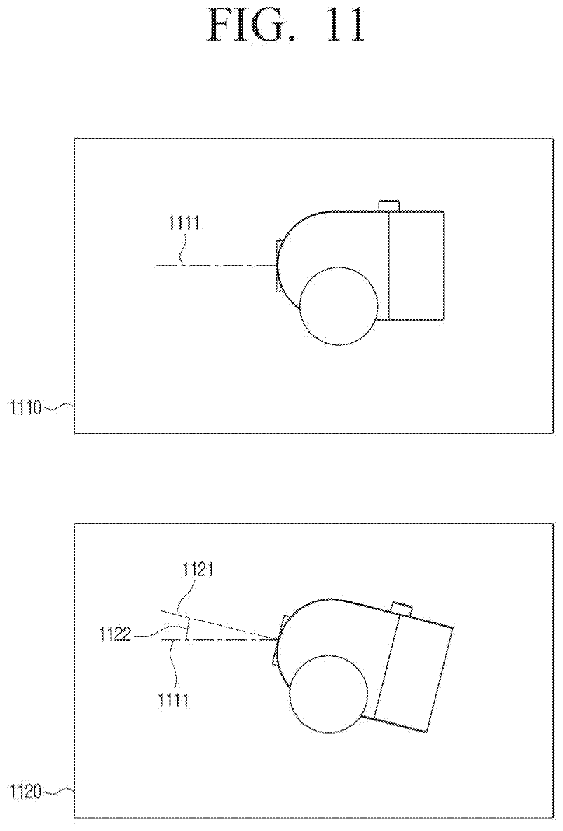

FIG. 11 is a diagram illustrating a vertical tilt according to an embodiment.

Referring to FIG. 11 according to Embodiment 1110, the electronic apparatus 100 may output a projection image onto a projection surface in a horizontal projection direction. It is assumed that the vertical tilt is 0. The vertical tilt may indicate a degree to which the electronic apparatus 100 is tilted upward or downward toward the front. When the vertical tilt is 0, it may indicate a situation in which the projection image is output horizontally. A virtual line 1111 indicating a floor surface and a virtual line 1121 indicating that the electronic apparatus 100 faces the front may be identical (or parallel) to each other.

According to Embodiment 1120, the electronic apparatus 100 may output a projection image onto the projection surface in the horizontal projection direction. It is assumed that a vertical tilt 1122 is 30 degrees. When the vertical tilt is 30 degrees upward, the electronic apparatus 100 may output the projection image onto the projection surface upward by 30 degrees. The virtual line 1111 indicating the floor surface and the virtual line 1121 indicating that the electronic apparatus 100 faces the front may not be parallel to each other. The vertical tilt 1122 may indicate an angle between the virtual line 1111 indicating the floor surface and the virtual line 1121 indicating that the electronic apparatus 100 faces the front.

The vertical tilt may indicate a rotation angle (pitch) about a y-axis illustrated in FIG. 13. The vertical tilt may be described as a pitch angle.

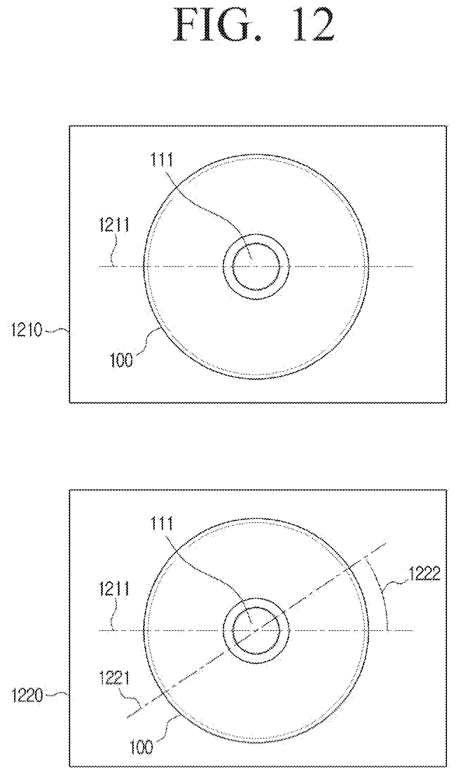

FIG. 12 is a diagram illustrating a horizontal misalignment according to an embodiment.

Referring to FIG. 12 according to Embodiment 1210, the electronic apparatus 100 may output a projection image without a horizontal misalignment. A reference without a horizontal misalignment is indicated by a horizontal line 1211. According to Embodiment 1210, a reference horizontal line and a horizontal line of the electronic apparatus 100 may be identical to each other.

According to Embodiment 1220, the electronic apparatus 100 may have a horizontal misalignment 1222 by 30 degrees to the right. The reference horizontal line 1211 and the horizontal line 1221 of the electronic apparatus may be misaligned by the horizontal misalignment 1222.

The horizontal misalignment may indicate a rotation angle (roll) about an x-axis illustrated in FIG. 13. The horizontal misalignment may be described as a roll angle.

FIG. 13 is a diagram illustrating rotation information of the electronic apparatus 100 according to an embodiment.

FIG. 13 is a diagram illustrating the horizontal misalignment, horizontal tilt, and vertical tilt of the electronic apparatus 100.

Embodiment 1310 of FIG. 13 shows a graph in which rotation directions with respect to x-, y-, and z-axes are defined. Rotation about the x-axis may be defined as roll, rotation about the y-axis may be defined as pitch, and rotation about the z-axis may be defined as yaw.

Embodiment 1320 of FIG. 13 may describe a rotation direction of the projection surface 10 as the rotation direction defined in Embodiment 1310. X-axis rotation information of the projection surface 10 may correspond to roll rotation about an x-axis of the projection surface 10. Y-axis rotation information of the projection surface 10 may correspond to pitch rotation about a y-axis of the projection surface 10. Z-axis rotation information of the projection surface 10 may correspond to yaw rotation about a z-axis of the projection surface 10.

The x-axis rotation information may be described as first-axis rotation information or horizontal misalignment information. The y-axis rotation information may be described as second-axis rotation information or vertical tilt information. The z-axis rotation information may be described as third-axis rotation information or horizontal tilt information.

The sensor unit 121 may acquire state information of the electronic apparatus 100. The state information of the electronic apparatus 100 may indicate a rotation state of the electronic apparatus 100. The sensor unit 121 may include at least one of a gravity sensor, an acceleration sensor, or a gyro sensor. X-axis rotation information of the electronic apparatus 100 and y-axis rotation information of the electronic apparatus 100 may be determined based on sensing data acquired by the sensor unit 121. However, it may be difficult to set a specific reference for z-axis rotation information of the electronic apparatus 100 unless based on east, west, south, north, and the like. Accordingly, the electronic apparatus 100 may consider state information of the projection surface 10 without separately considering the z-axis rotation information of the electronic apparatus 100. Specifically, the electronic apparatus 100 may perform an image correction operation in consideration of the z-axis rotation information of the projection surface 10.

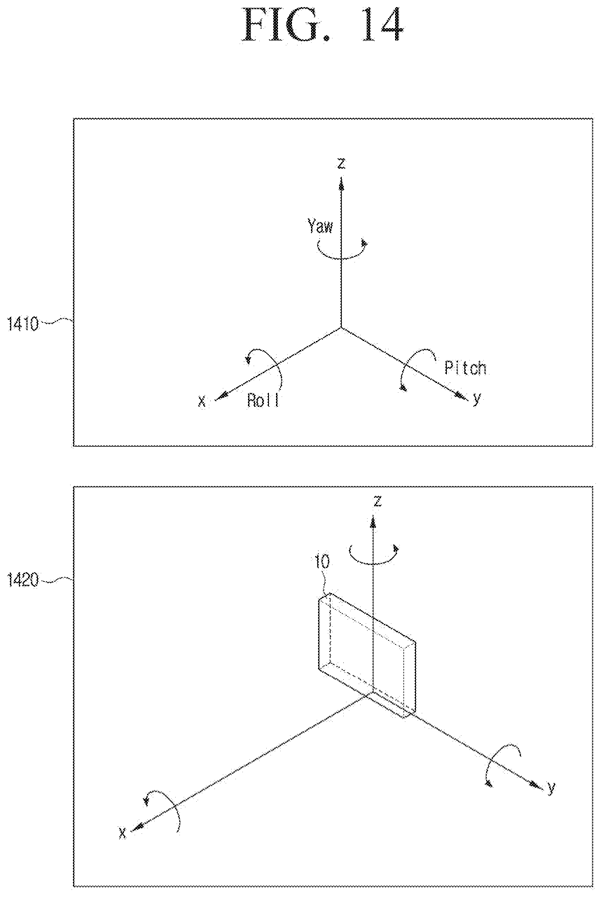

FIG. 14 is a diagram illustrating the rotation information of a projection surface according to an embodiment.

Embodiment 1410 of FIG. 14 shows a graph in which rotation directions with respect to the x-, y-, and z-axes are defined. Rotation about the x-axis may be defined as roll, rotation about the y-axis may be defined as pitch, and rotation about the z-axis may be defined as yaw.

Embodiment 1420 of FIG. 14 may describe a rotation direction of the projection surface 10 as the rotation direction defined in Embodiment 1410. The x-axis rotation information of the projection surface 10 may correspond to the roll rotation based on the x-axis of the projection surface 10. The y-axis rotation information of the projection surface 10 may correspond to the pitch rotation based on the y-axis of the projection surface 10. The z-axis rotation information of the projection surface 10 may correspond to the yaw rotation based on the z-axis of the projection surface 10.

The x-axis rotation information may be described as the first-axis rotation information. The y-axis rotation information may be described as the second-axis rotation information. The z-axis rotation information may be described as the third-axis rotation information.

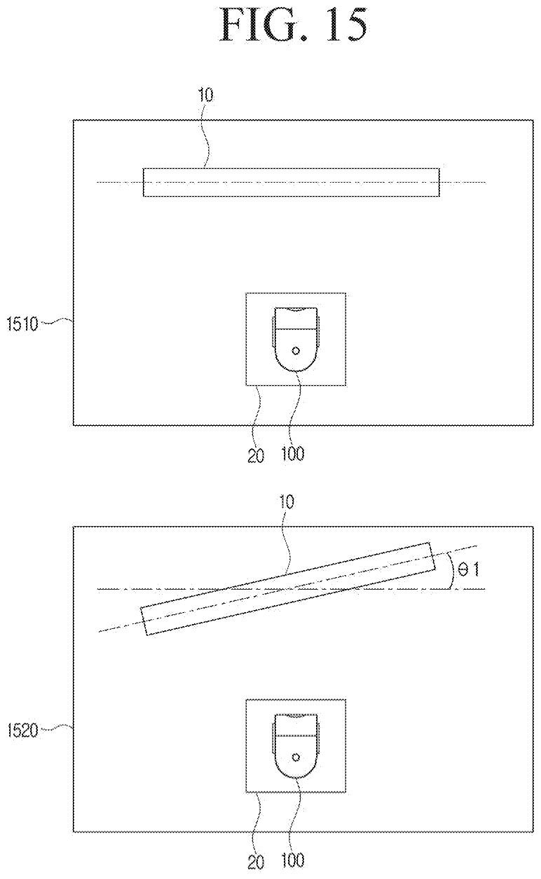

FIG. 15 is a diagram illustrating the z-axis rotation information of the projection surface according to an embodiment.

Embodiment 1510 of FIG. 15 shows a diagram, viewed from above the electronic apparatus 100, illustrating a situation in which the electronic apparatus 100 outputs a projection image in a state in which the projection surface 10 is not rotated about the z-axis. It is assumed that the electronic apparatus 100 is placed on a table 20.

Embodiment 1520 of FIG. 15 shows a diagram, viewed from above the electronic apparatus 100, illustrating a situation in which the electronic apparatus 100 outputs a projection image in a state in which the projection surface 10 is rotated counterclockwise by a predetermined angle θ1 about the z-axis. It is assumed that the electronic apparatus 100 is placed on the table 20.

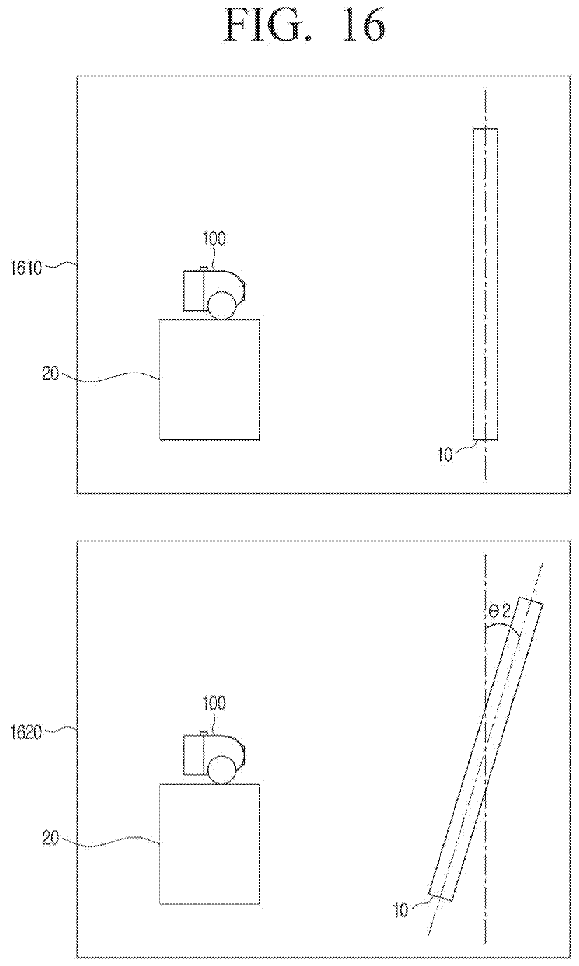

FIG. 16 is a diagram illustrating the y-axis rotation information of the projection surface according to an embodiment.

Embodiment 1610 of FIG. 16 shows a state in which the projection surface 10 is not rotated about the y-axis.

Embodiment 1620 of FIG. 16 shows a state in which the projection surface 10 is rotated about the y-axis. Specifically, it is assumed that the projection surface 10 is rotated by a predetermined angle θ2 about the y-axis.

FIG. 17 is a diagram illustrating an operation of performing a keystone function in consideration of the vertical tilt according to an embodiment.

Referring to Embodiment 1710 of FIG. 17, the electronic apparatus 100 may output a projection image in a state in which the vertical tilt is present.

Referring to Embodiment 1720, the electronic apparatus 100 may output a projection image 1721 in a state in which the vertical tilt is present, and due to the vertical tilt, the projection image 1721 may be output in a trapezoidal shape rather than a rectangular shape corresponding to an original image shape. To solve a problem caused by the presence of the vertical tilt, the electronic apparatus 100 may perform the keystone function.

Referring to Embodiment 1730, the electronic apparatus 100 may perform the keystone function to allow a finally output projection image 1731 to have the rectangular shape by transforming the original image.

FIG. 18 is a diagram illustrating an operation of performing the keystone function in consideration of the horizontal tilt according to an embodiment.

Referring to Embodiment 1810 of FIG. 18, the electronic apparatus 100 may output a projection image in a state in which the horizontal tilt is present.

Referring to Embodiment 1820, the electronic apparatus 100 may output a projection image 1821 in a state in which the horizontal tilt is present, and due to the horizontal tilt, the projection image 1821 may be output in a trapezoid shape rather than a rectangular shape corresponding to an original image shape. To solve a problem caused by the presence of the horizontal tilt, the electronic apparatus 100 may perform the keystone function.

Referring to Embodiment 1830, the electronic apparatus 100 may perform the keystone function to allow a finally output projection image 1831 to have the rectangular shape by transforming the original image.

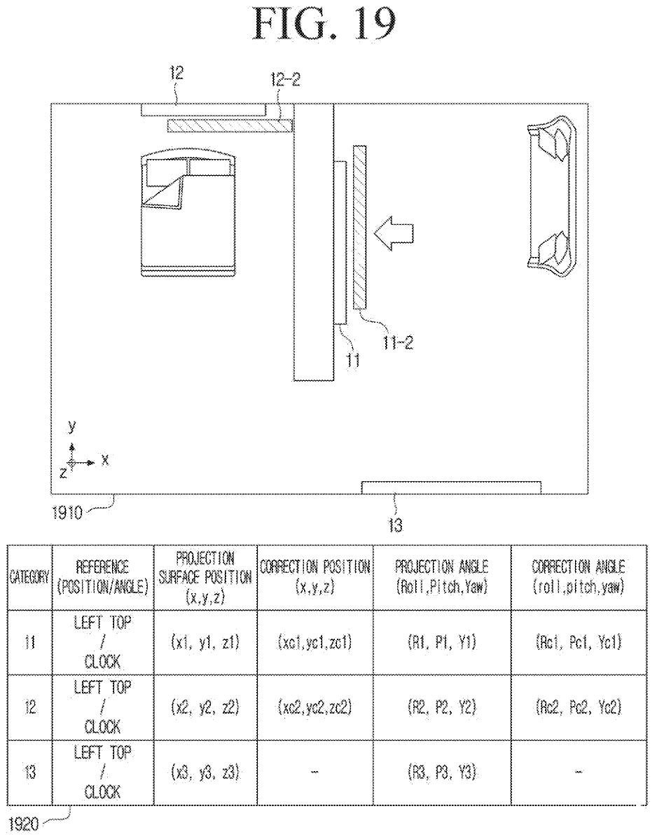

FIG. 19 is a diagram illustrating an operation of storing the projection information according to an embodiment.

According to Embodiment 1910 of FIG. 19, information about a plurality of projection surfaces 11, 12, and 13 may be stored in the memory 113. The information about each of the plurality of projection surfaces 11, 12, and 13 may be described as the projection information.

The projection information may include at least one of a projection surface criterion, the projection surface position, the correction position, the projection angle, or the correction angle. The projection information may include the correction information, and the correction information may include at least one of the correction position or the correction angle.

The projection surface criterion may include information defining a criterion of the projection surface to define the projection surface. The criterion of the projection surface may be described as criterion information of the projection surface. The criterion of the projection surface may include at least one of a coordinate criterion or an angle criterion.

The coordinate criterion may indicate a criterion corresponding to a three-dimensional coordinate axis (or a two-dimensional coordinate axis). The coordinate criterion may be one of left top, left bottom, right top, or right bottom.

The angle criterion may indicate a criterion corresponding to three-dimensional rotation axes (roll, pitch, and yaw). The angle criterion may be at least one of a clockwise direction or a counterclockwise direction.

The correction position may indicate a position acquired by correcting the projection surface position.

The correction angle may indicate a value acquired by correcting an angle related to output of a projection image.

It is assumed that, among the plurality of projection surfaces 11, 12, and 13, a user correction history is present for the projection surface 11 and the projection surface 12, and no correction history does is present for the projection surface 13.

The electronic apparatus 100 may identify a position (x1, y1, z1) of the projection surface 11. The electronic apparatus 100 may acquire the correction position (xc1, yc1, zc1) for the position (x1, y1, z1) of the projection surface 11. When correction for the projection surface 11 is completed, the electronic apparatus 100 may identify a corrected projection surface 11-2.

The electronic apparatus 100 may identify a projection angle (R1, P1, Y1) of the projection surface 11. The electronic apparatus 100 may acquire a correction angle (Rc1, Pc1, Yc1) for the projection angle (R1, P1, Y1) of the projection surface 11.

For example, the correction angle (Rc1, Pc1, Yc1) may be determined based on the position of the projection surface 11-2. When the position of the projection surface 11-2 is corrected, the electronic apparatus 100 may change the projection angle (R1, P1, Y1) based on the correction angle (Rc1, Pc1, Yc1).

For example, the correction angle (Rc1, Pc1, Yc1) may be determined based on a user input for changing the correction angle (or an automatically determined correction value).

The electronic apparatus 100 may acquire and store first projection information including at least one of the projection surface position (x1, y1, z1), the correction position (xc1, yc1, zc1), the projection angle (R1, P1, Y1), or the correction angle (Rc1, Pc1, Yc1). The first projection information may be information corresponding to the first projection surface 11.

The electronic apparatus 100 may identify a position (x2, y2, z2) of the projection surface 12. The electronic apparatus 100 may acquire a correction position (xc2, yc2, zc2) for the position (x2, y2, z2) of the projection surface 12. When correction for the projection surface 12 is completed, the electronic apparatus 100 may identify a corrected projection surface 12-2.

The electronic apparatus 100 may identify a projection angle (R2, P2, Y2) of the projection surface 12. The electronic apparatus 100 may acquire a correction angle (Rc2, Pc2, Yc2) for the projection angle (R2, P2, Y2) of the projection surface 12.

For example, the correction angle (Rc2, Pc2, Yc2) may be determined based on the position of the projection surface 12-2. When the position of the projection surface 12-2 is corrected, the electronic apparatus 100 may change the projection angle (R2, P2, Y2) based on the correction angle (Rc2, Pc2, Yc2).

For example, the correction angle (Rc2, Pc2, Yc2) may be determined based on a user input for changing the correction angle (or an automatically determined correction value).

The electronic apparatus 100 may acquire and store the second projection information including at least one of the projection surface position (x2, y2, z2), the correction position (xc2, yc2, zc2), the projection angle (R2, P2, Y2), or the correction angle (Rc2, Pc2, Yc2). The second projection information may be information corresponding to the second projection surface 12.

The electronic apparatus 100 may identify a position (x3, y3, z3) of the projection surface 13. The electronic apparatus 100 may identify a projection angle (R3, P3, Y3) of the projection surface 13.

The electronic apparatus 100 may acquire and store third projection information including at least one of the projection surface position (x3, y3, z3), a correction position (xc3, yc3, zc3), the projection angle (R3, P3, Y3), or a correction angle (Rc3, Pc3, Yc3). The third projection information may be information corresponding to the third projection surface 13.

A table 1920 of FIG. 19 may indicate the history information including the first projection information, the second projection information, and the third projection information.

FIG. 20 is a diagram illustrating an operation of performing correction based on projection information according to an embodiment.

Embodiment 2010 of FIG. 20 illustrates a situation in which a projection image is output onto a projection surface 21 corresponding to the projection surface 11.

The electronic apparatus 100 may determine to output a projection image onto the projection surface 21 based on a user command. The electronic apparatus 100 may determine whether projection information corresponding to the projection surface 21 is included in history information 2020.

It is assumed that a y coordinate of the projection surface 11 and a y coordinate of the projection surface 21 are identical to each other. It is assumed that a z coordinate of the projection surface 11 and a z coordinate of the projection surface 21 are identical to each other. The electronic apparatus 100 may identify that the projection surface 21 corresponds to the projection surface 11. The electronic apparatus 100 may determine that the projection surface 21 is parallel to the projection surface 11.

When the projection surface 21 is identified as corresponding to the projection surface 11, the electronic apparatus 100 may correct the projection surface position and the projection angle based on the first projection information related to the projection surface 11.

When it is determined to output a projection image onto the projection surface 21 based on the user command, the electronic apparatus 100 may identify a projection surface position (x4, y4, z4) related to the projection surface 21. The electronic apparatus 100 may acquire a projection angle (R4, P4, Y4) based on the projection surface position (x4, y4, z4).

The electronic apparatus 100 may determine whether a projection surface corresponding to the projection surface 21 is included in history information 2020. The electronic apparatus 100 may determine whether a projection surface position corresponding to the projection surface position (x4, y4, z4) is included in the history information 2020. Correspondence between projection surfaces or projection surface positions may indicate that comparison targets are parallel to each other. The electronic apparatus 100 may determine whether a projection surface parallel to the projection surface 21 is included in the history information 2020.

It is assumed that the projection surface 21 is parallel to the projection surface 11. The electronic apparatus 100 may identify the first projection information corresponding to the projection surface 11 related to the projection surface position (x1, y1, z1). The electronic apparatus 100 may acquire, based on the first projection information, at least one of the correction position (xc1, yc1, zc1) or the correction angle (Rc1, Pc1, Yc1).

The electronic apparatus 100 may change the projection surface position (x4, y4, z4) based on the correction position (xc1, yc1, zc1). The electronic apparatus 100 may change the projection angle (R4, P4, Y4) based on the correction angle (Rc1, Pc1, Yc1).

The electronic apparatus 100 may output a projection image based on at least one of a corrected projection surface position or a corrected projection angle.

The electronic apparatus 100 may determine whether to additionally change the correction information in consideration of the projection direction. The first projection information may include the projection position. The electronic apparatus 100 may acquire the first projection direction (or the first projection vector) indicating from the first projection position to the first projection surface position, in relation to the projection surface 11.

The electronic apparatus 100 may acquire the second projection direction (or the second projection vector) indicating from the second projection position to the second projection surface position, in relation to the projection surface 21.

The electronic apparatus 100 may determine whether the first projection direction and the second projection direction are identical to each other. When the first projection direction and the second projection direction are identical to each other, the electronic apparatus 100 may not change the first correction information. The electronic apparatus 100 may correct at least one of the projection surface position (x4, y4, z4) or the projection angle (R4, P4, Y4) based on the first correction information.

A projection surface position 21-2 of FIG. 20 may indicate a corrected projection surface position.

A table 2030 may indicate projection information for the projection surface 21.

FIG. 21 is a diagram illustrating an operation of performing correction based on projection information according to an embodiment.

Embodiment 2110 of FIG. 21 may have a projection direction opposite to that of Embodiment 2010 of FIG. 20. In an embodiment of FIG. 21, it is assumed that the projection surface 11 and the projection surface 22 are parallel to each other. In FIG. 21, a situation is assumed in which the projection surface position is corrected based on a direction in which the electronic apparatus 100 faces the projection surface. The electronic apparatus 100 may correct the projection surface position in the same direction (right) based on a direction in which the electronic apparatus 100 faces the projection surfaces 11 and 22.

A table 2120 may correspond to the table 2020 of FIG. 20. A redundant description is omitted. The table 2120 may indicate the history information including the projection information for a plurality of projection surfaces.

A table 2130 may indicate projection information for the projection surface 22.

The electronic apparatus 100 may acquire the second projection direction (or the second projection vector) indicating from the second projection position to the second projection surface position, in relation to the projection surface 22.

When the first projection direction and the second projection direction are not identical to each other, the electronic apparatus 100 may acquire a difference value between the first projection direction and the second projection direction. The electronic apparatus 100 may change the first correction information to the second correction information based on the difference value.

The electronic apparatus 100 may correct at least one of the projection surface position (x4, y4, z4) or the projection angle (R4, P4, Y4) based on the second correction information.

The second correction information may include at least one of a second correction position (−xc1, yc1, zc1) or a second correction angle (−Rc1, Pc1, Yc1).

The electronic apparatus 100 may change the first correction position (xc1, yc1, zc1) to a second correction position (−xc1, −yc1, zc1) based on the difference value. When the projection direction is opposite to the x-axis direction, the electronic apparatus 100 may change the x coordinate and y coordinate of the correction position by the difference value (by applying a negative value thereto).

The electronic apparatus 100 may change the first correction angle (Rc1, Pc1, Yc1) to a second correction angle (−Rc1, Pc1, Yc1) based on the difference value. When the projection direction is opposite to the x-axis direction, the electronic apparatus 100 may change a roll angle of the correction angle by the difference value (by applying a negative value thereto).

A projection surface position 22-2 of FIG. 21 may indicate a corrected projection surface position.

FIG. 22 is a diagram illustrating an operation of performing correction based on projection information according to an embodiment.

In Embodiment 2210 of FIG. 22, the electronic apparatus 100 may correct the projection surface position in an opposite direction (left) based on the direction in which the electronic apparatus 100 faces the projection surfaces 11 and 22. The electronic apparatus 100 may correct the projection surface position to be closer to a wall surface to output a projection image closer to the wall surface.

A table 2220 may correspond to the table 2020 of FIG. 20. A redundant description is omitted. The table 2220 may indicate the history information including projection information for a plurality of projection surfaces.

A table 2230 may indicate the projection information for the projection surface 22.

The electronic apparatus 100 may change the first correction position (xc1, yc1, zc1) to a second correction position (−xc1, yc1, zc1) based on a difference value. When a projection direction is opposite to the x-axis direction, the electronic apparatus 100 may change an x coordinate of the correction position by the difference value (by applying a negative value thereto).

The electronic apparatus 100 may change the first correction angle (Rc1, Pc1, Yc1) to a second correction angle (−Rc1, Pc1, −Yc1) based on the difference value. When a projection direction is opposite to the x-axis direction, the electronic apparatus 100 may change the roll angle and yaw angle of the correction angle by the difference value (by applying a negative value thereto).

A projection surface position 22-3 of FIG. 22 may indicate a corrected projection surface position.

The correction position and the correction angle described with reference to FIGS. 21 and 22 may indicate correction values applied to the correction operation.

According to various embodiments, the correction position and the correction angle may indicate final values acquired after the correction operation is completed.

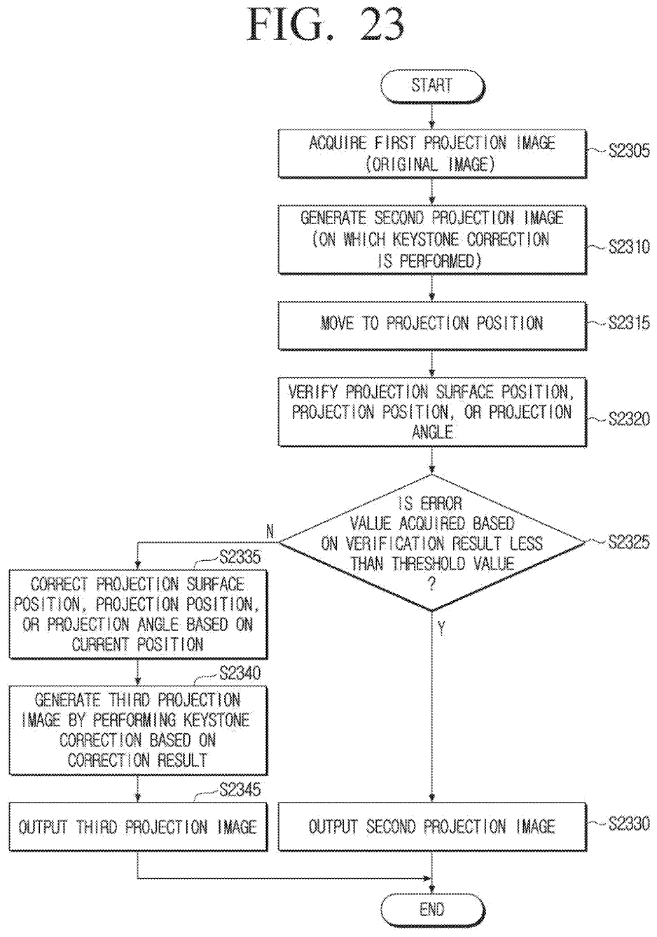

FIG. 23 is a diagram illustrating an operation of performing verification after movement of the electronic apparatus 100 to a projection position according to an embodiment.

Referring to FIG. 23, the electronic apparatus 100 may acquire a first projection image (an original image) (S2305). The electronic apparatus 100 may generate a second projection image on which the keystone correction is performed (S2310). The electronic apparatus 100 may move to a determined projection position (S2315). The electronic apparatus 100 may verify at least one of the projection surface position, the projection position, or the projection angle (S2320).

The electronic apparatus 100 may acquire an error value based on a verification result. The electronic apparatus 100 may acquire the second projection surface position, the second projection position, and the second projection angle before movement to the second projection position. The electronic apparatus 100 may perform a verification operation after the movement to the second projection position. The electronic apparatus 100 may perform verification for each of the second projection surface position, the second projection position, and the second projection angle at the second projection position.

Unlike the projection information stored in the history information, an obstacle may be present or a floor slope may be changed. The electronic apparatus 100 may determine, based on the verification result, whether to change at least one of the projection surface position, the projection position, or the projection angle again. After the movement to the second projection position, the electronic apparatus 100 may acquire the third projection surface position, the third projection position, and the third projection angle, respectively, for verification. The electronic apparatus 100 may perform the verification operation by comparing information acquired before movement (the second projection surface position, the second projection position, and the second projection angle) and information acquired after movement (the third projection surface position, the third projection position, and the third projection angle).

The electronic apparatus 100 may identify whether the error value acquired based on the verification result is less than a threshold value (S2325). The electronic apparatus 100 may identify, as the error value, a difference value between the information acquired before movement (the second projection surface position, the second projection position, and the second projection angle) and the information acquired after movement (the third projection surface position, the third projection position, and the third projection angle).

When the error value is less than the threshold value (S2325-Y), the electronic apparatus 100 may output the second projection image (S2330).

When the error value is not less than the threshold value (S2325-N), the electronic apparatus 100 may correct at least one of the projection surface position, the projection position, or the projection angle based on the current position (S2335).

The electronic apparatus 100 may generate a third projection image by performing the keystone correction based on a correction result (S2340). The electronic apparatus 100 may output the third projection image (S2345).

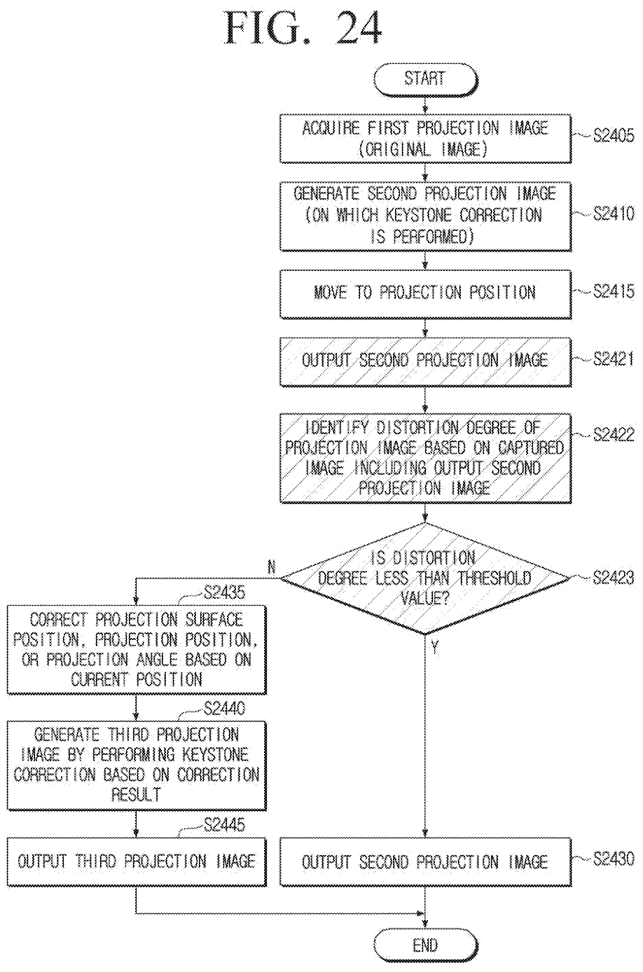

FIG. 24 is a diagram illustrating an operation of performing verification after the movement of the electronic apparatus 100 to the projection position according to an embodiment.

Steps S2405, S2410, S2415, S2430, S2435, S24450, and S2445 of FIG. 24 may correspond to steps S2305, S2310, S2315, S2330, S2335, S2340, and S2345 of FIG. 23. A redundant description is omitted.

After the movement to the projection position, the electronic apparatus 100 may output the second projection image (S2421). The electronic apparatus 100 may acquire a captured image including the output second projection image from the image sensor 121-1 included in the sensor unit 121.

The electronic apparatus 100 may identify a distortion degree of a projection image output onto a projection surface based on the captured image (S2422). The electronic apparatus 100 may calculate the distortion degree of the projection image based on the captured image.

When the distortion degree is less than a threshold value (S2423-Y), the electronic apparatus 100 may output the second projection image.

When the distortion degree is not less than the threshold value (S2423-N), the electronic apparatus 100 may perform steps S2435, S2440, and S2445.

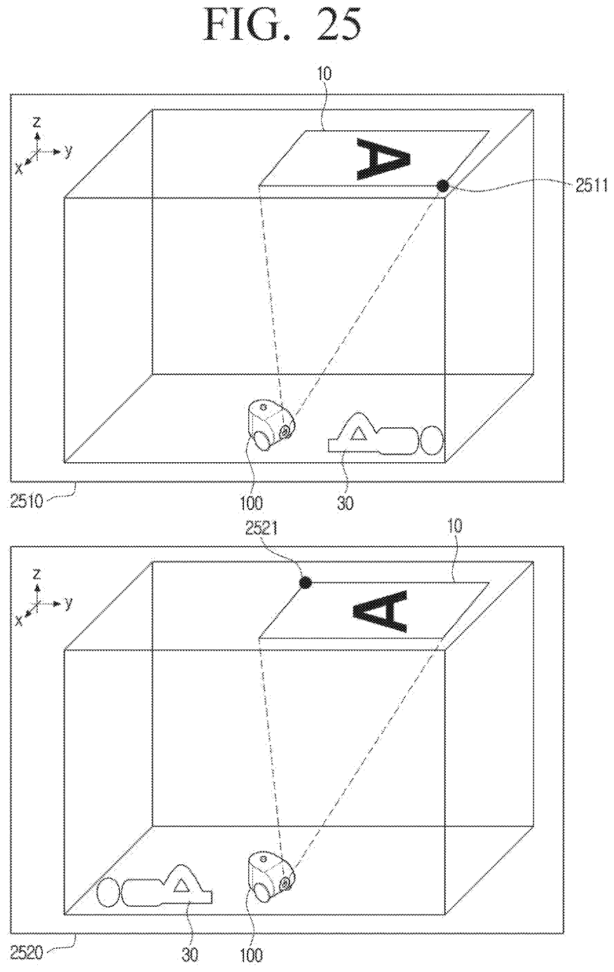

FIG. 25 is a diagram illustrating an operation of determining a projection reference point in consideration of a user position according to an embodiment.

The electronic apparatus 100 may determine a part of a ceiling as the projection surface 10. When a projection image is output onto the ceiling, a vertical direction of the projection image may be determined based on a reference point. It is assumed that the reference point of the projection image is the leftmost and uppermost point.

The electronic apparatus 100 may determine the reference point of the projection image based on the user position.

In Embodiment 2510, the electronic apparatus 100 may output a projection image based on the projection surface 10 and a reference point 2511 based on a position of a user 30.

In Embodiment 2520, the electronic apparatus 100 may output a projection image based on the projection surface 10 and a reference point 2521 based on a position of the user 30.

The electronic apparatus 100 may identify candidate reference points 2511 and 2521 among four vertices indicating the projection surface 10. The electronic apparatus 100 may determine one of the candidate reference points 2511 and 2521 as a final reference point based on the user position. The electronic apparatus 100 may determine a candidate reference point closer to the user position as the final reference point among the candidate reference points 2511 and 2521.

In Embodiment 2510, the electronic apparatus 100 may determine the reference point 2511 closer to the position of the user 30 as the final reference point among the candidate reference points 2511 and 2521.

In the embodiment 2520, the electronic apparatus 100 may determine the reference point 2521 closer to the position of the user 30 as the final reference point among the candidate reference points 2511 and 2521.

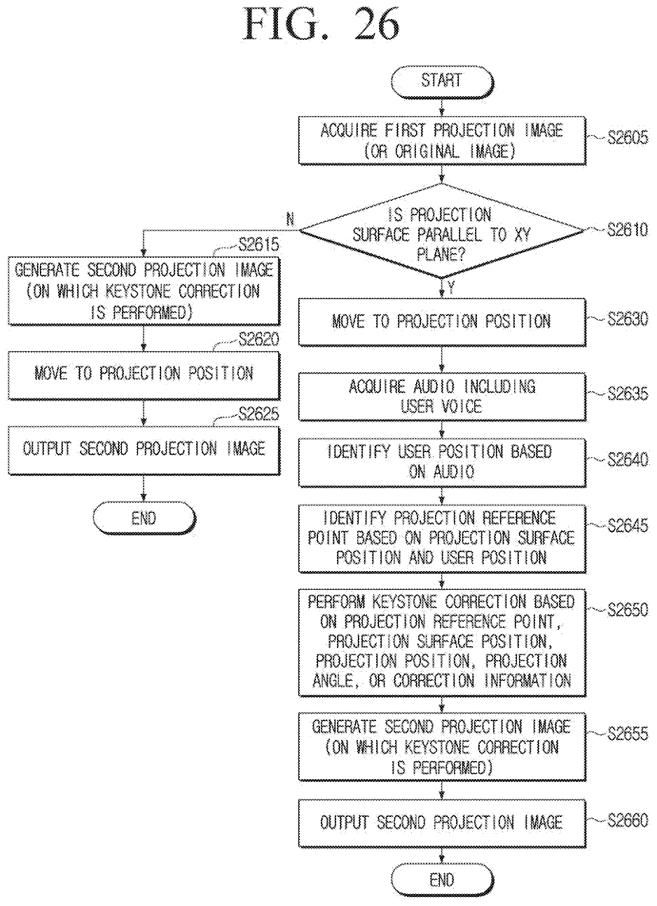

FIG. 26 is a diagram illustrating an operation of performing the keystone correction in consideration of the projection reference point according to an embodiment.

Referring to FIG. 26, the electronic apparatus 100 may acquire the first projection image (or the original image) (S2605). The electronic apparatus 100 may determine whether the projection surface is parallel to an xy plane (S2610).

When the projection surface is not parallel to the xy plane (S2610-N), the electronic apparatus 100 may generate the second projection image on which the keystone correction is performed (S2615). The electronic apparatus 100 may move to the projection position (S2620). After the movement to the second projection position, the electronic apparatus 100 may output the second projection image (S2625).

When the projection surface is parallel to the xy plane (S2610-Y), the electronic apparatus 100 may move to the projection position (S2630). The electronic apparatus 100 may acquire audio (or an audio signal) including a user voice (S2635).

The electronic apparatus 100 may identify a user position based on the audio (S2640). The electronic apparatus 100 may identify the projection reference point based on the projection surface position and the user position (S2645).

The electronic apparatus 100 may perform the keystone correction based on at least one of the projection reference point, the projection surface position, the projection position, the projection angle, or the correction information (S2650). The electronic apparatus 100 may generate the second projection image on which the keystone correction is performed (S2655). The electronic apparatus 100 may output the second projection image (S2660).

FIG. 27 is a diagram illustrating an operation of outputting a projection image during the movement of the electronic apparatus 100 according to an embodiment.

Referring to FIG. 27, the electronic apparatus 100 may continuously output a projection image even during the movement.

According to Embodiment 2710, the electronic apparatus 100 may output a projection image 2711 on which the keystone correction is performed by performing the keystone correction based on the first position.

According to Embodiment 2720, the electronic apparatus 100 may output a projection image 2721 on which the keystone correction is performed by performing the keystone correction based on the second position.

The electronic apparatus 100 may perform the keystone correction based on a movement position during the movement from the first position to the second position. The electronic apparatus 100 may output a projection image on which the keystone correction is performed at each position.

The electronic apparatus 100 may continuously output a projection image even during the movement to a destination. The electronic apparatus 100 may perform the keystone correction in real time, and accordingly, the electronic apparatus 100 may output a projection image without distortion even during the movement.

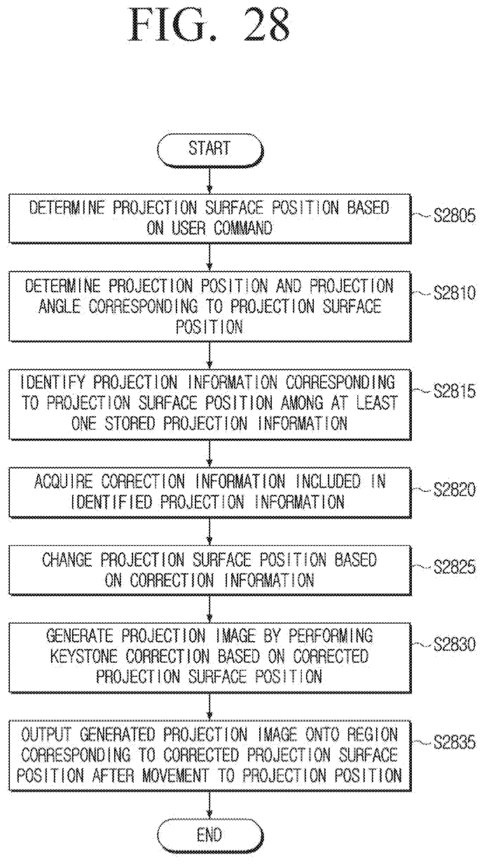

FIG. 28 is a diagram illustrating a control operation of an electronic apparatus 100 according to an embodiment.

Referring to FIG. 28, provided is a control method of an electronic apparatus storing at least one projection information, the method including: determining the projection surface position based on a user command (S2805); determining the projection position and the projection angle corresponding to the projection surface position (S2810); identifying the projection information corresponding to the projection surface position among at least one stored projection information (S2815); acquiring the correction information included in the identified projection information (S2820); changing the projection surface position based on the correction information (S2825); generating the projection image by performing the keystone correction based on the corrected projection surface position (S2830); and outputting the generated projection image onto a region corresponding to the corrected projection surface position after movement to the projection position (S2835).

The electronic apparatus may store the first projection information including at least one of the first projection surface position or the first correction information, the first correction information may be information used to change the first projection surface position, and the control method may further include: determining the second projection surface position based on the user command; and identifying whether the second projection surface position corresponds to the first projection surface position.

The acquiring of the correction information (S2820) may include acquiring the first correction information included in the first projection information when the second projection surface position corresponds to the first projection surface position, the changing of the projection surface position may include changing the second projection surface position to the third projection surface position based on the first correction information, and the control method may further include performing movement to output the projection image onto the third projection surface position.

The changing of the projection surface position (S2825) may include acquiring the first projection direction corresponding to the first projection surface position when the second projection surface position corresponds to the first projection surface position, acquiring the second projection direction corresponding to the second projection surface position, and changing the second projection surface position to the third projection surface position based on the first correction information when the second projection direction corresponds to the first projection direction.

The changing of the projection surface position (S2825) may include acquiring the first projection direction based on the first projection position and the first projection surface position included in the first projection information, acquiring the second projection direction based on the second projection position and the second projection surface position corresponding to the second projection surface position, and identifying whether the second projection direction corresponds to the first projection direction based on the difference value between the first projection direction and the second projection direction.

The changing of the projection surface position (S2825) may include changing the second projection surface position to the third projection surface position based on the first correction information when the difference value between the first projection direction and the second projection direction is less than the threshold value.

The changing of the projection surface position (S2825) may include, when the difference value between the first projection direction and the second projection direction is not less than the threshold value, changing the first correction information to the second correction information based on the difference value, and changing the second projection surface position to the fourth projection surface position based on the second correction information.

The generating of the projection image (S2830) may include changing at least one of the projection position or the projection angle based on the corrected projection surface position, and generating the projection image by performing the keystone correction based on at least one of the corrected projection surface position, the changed projection position, or the changed projection angle.

The generating of the projection image (S2830) may include verifying at least one of the corrected projection surface position, the projection position, or the projection angle after movement of the electronic apparatus 100 to the projection position, and generating the projection image by performing the keystone correction based on the verification result.

The control method may further include outputting the projection image during the movement of the electronic apparatus 100 to the projection position.

The methods according to the various embodiments of the present disclosure described above may be implemented in the form of an application capable of being installed on a conventional electronic apparatus.

The methods according to the various embodiments of the present disclosure described above may be implemented only by software upgrade or hardware upgrade of the conventional electronic apparatus.

The various embodiments of the present disclosure described above may be performed through an embedded server included in the electronic apparatus, or through an external server of at least one of the electronic apparatus or a display device.

According to an embodiment of the present disclosure, the various embodiments described above may be implemented by software including an instruction stored on a machine-readable storage medium, the instructions being readable by a machine (e.g., a computer). The machine may be a device that invokes the stored instruction from a storage medium, may be operated based on the invoked instruction, and may include the electronic apparatus according to the disclosed embodiments. When the instruction is executed by the processor, the processor may directly perform, or perform functions corresponding to the instructions by using other components under control of the processor. The instruction may include codes generated or executed by a compiler or an interpreter. The machine-readable storage medium may be provided in the form of a non-transitory storage medium. Here, the term “non-transitory” merely indicates that the storage medium is tangible without including a signal, and does not distinguish whether data are semi-permanently or temporarily stored in the storage medium.

According to an embodiment of the present disclosure, the methods according to the various embodiments described above may be provided by being included in a computer program product. The computer program product may be traded as a product between a seller and a buyer. The computer program product may be distributed in the form of a machine-readable storage medium (e.g., a compact disc read only memory (CD-ROM)) or online through an application store. In the case of online distribution, at least a part of the computer program product may be temporarily stored or generated in a storage medium such as a memory of a manufacturer server, an application store server, or a relay server.

Each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before integration in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

Although the preferred embodiments of the present disclosure are illustrated and described as above, the present disclosure is not limited to the above-described specific embodiments, and may be variously modified by those skilled in the art to which the present disclosure pertains without departing from the scope of the present disclosure as claimed in the accompanying claims. These modifications should also be understood to fall within the spirit of the present disclosure.

1. An electronic apparatus comprising:
a projection unit;
a memory to store at least one projection information; and
at least one processor configured to:
identify a projection position and a projection angle corresponding to a projection surface position on which an image is to be output based on a user command;
acquire correction information included in projection information corresponding to the projection surface position among the at least one projection information stored in the memory; and
move the projection position onto a region corresponding to the projection surface position that is corrected based on the correction information and control the projection unit to output the image which is acquired using keystone correction based on the region corresponding to the projection surface position corrected based on the correction information.

2. The electronic apparatus as claimed in claim 1, wherein the memory stores first projection information including at least one of a first projection surface position or first correction information,
the first correction information includes information to correct the first projection surface position to a third projection surface position, and
the at least one processor is configured to:
identify whether a second projection surface position identified based on the user command corresponds to the first projection surface position.

3. The electronic apparatus as claimed in claim 2, wherein the at least one processor is configured to:
based on the second projection surface position corresponding to the first projection surface position,
correct the second projection surface position to the third projection surface position based on the first correction information included in the first projection information; and
move to output the image onto the third projection surface position.

4. The electronic apparatus as claimed in claim 3, wherein the at least one processor is configured to:
acquire a first projection direction corresponding to the first projection surface position based on the second projection surface position corresponding to the first projection surface position;
acquire a second projection direction corresponding to the second projection surface position; and
change the second projection surface position to the third projection surface position based on the first correction information based on the second projection direction corresponding the first projection direction.

5. The electronic apparatus as claimed in claim 4, wherein the at least one processor is configured to:
acquire the first projection direction based on a first projection position included in the first projection information and the first projection surface position;
acquire the second projection direction based on a second projection position corresponding to the second projection surface position and the second projection surface position; and
identify whether the second projection direction corresponds to the first projection direction based on a difference value between the first projection direction and the second projection direction.

6. The electronic apparatus as claimed in claim 5, wherein the at least one processor is configured to:
change the second projection surface position to the third projection surface position based on the first correction information based on the difference value between the first projection direction and the second projection direction being less than a threshold value.

7. The electronic apparatus as claimed in claim 5, wherein the at least one processor is configured to:
based on the difference value between the first projection direction and the second projection direction being greater than a threshold value,
change the first correction information to second correction information based on the difference value; and
change the second projection surface position to a fourth projection surface position based on the second correction information.

8. The electronic apparatus as claimed in claim 1, wherein the at least one processor is configured to:
change at least one of the projection position or the projection angle based on the projection surface position that is corrected; and
control the projection unit to output the image acquired using the keystone correction based on at least one of the projection surface position that is corrected, the projection position that is changed, or the projection angle that is changed.

9. The electronic apparatus as claimed in claim 1, wherein the at least one processor is configured to:
verify at least one of the projection surface position that is corrected, the projection position, or the projection angle after the projection position is moved; and
control the projection unit to output the image acquired using the keystone correction based on a verification result.

10. The electronic apparatus as claimed in claim 1, wherein the at least one processor is configured to:
control the projection unit to output the image while the projection position is being moved.

11. A control method of an electronic apparatus storing at least one projection information, the control method comprising:
identifying a projection position and a projection angle corresponding to a projection surface position on which an image is to be output based on a user command;
acquiring correction information included in projection information corresponding to the projection surface position among the at least one projection information that is stored; and
moving the projection position onto a region corresponding to the projection surface position that is corrected based on the correction information and outputting the image which is acquired using keystone correction based on the region corresponding to the projection surface position corrected based on the correction information.

12. The control method as claimed in claim 11, wherein the electronic apparatus stores first projection information including at least one of a first projection surface position or first correction information,
the first correction information includes information for correcting the first projection surface position to a third projection surface position, and
the control method comprising:
identifying whether a second projection surface position identified based on the user command corresponds to the first projection surface position.

13. The control method as claimed in claim 12, the control method comprising:
based on the second projection surface position corresponding the first projection surface position, correcting the second projection surface position to the third projection surface position based on the first correction information included in the first projection information, and
moving the projection position to output the image onto the third projection surface position.

14. The control method as claimed in claim 13, the control method comprising:
acquiring a first projection direction corresponding to the first projection surface position based on the second projection surface position corresponding to the first projection surface position;
acquiring a second projection direction corresponding to the second projection surface position; and
changing the second projection surface position to the third projection surface position based on the first correction information based on the second projection direction corresponding to the first projection direction.

15. The control method as claimed in claim 14, the control method comprising:
acquiring the first projection direction based on a first projection position included in the first projection information and the first projection surface position;
acquiring the second projection direction based on a second projection position corresponding to the second projection surface position and the second projection surface position; and
identifying whether the second projection direction corresponds to the first projection direction based on a difference value between the first projection direction and the second projection direction.
